(19) United States
(12) Patent Application Publication
(10) Pub. No.: US 2011/0235901 A1
(43) Pub. Date: Sep. 29, 2011

(54) METHOD, APPARATUS, AND PROGRAM FOR GENERATING CLASSIFIERS

(76) Inventor: Yi HU, Kanagawa-ken (JP)

(21) Appl. No.: 13/024,959

(22) Filed: Feb. 10, 2011

(30) Foreign Application Priority Data
Mar. 23, 2010 (JP) 065537/2010

(51) Int. Cl. G06K 9/62

(52) U.S. Cl. 382/159

(57) ABSTRACT

Classifiers, which are combinations of a plurality of weak classifiers, for discriminating objects included in detection target images by employing features extracted from the detection target images to perform multi class discrimination including a plurality of classes regarding the objects are generated. When the classifiers are generated, branching positions and branching structures of the weak classifiers of the plurality of classes are determined, according to the learning results of the weak classifiers in each of the plurality of classes.

### BACKGROUND OF THE INVENTION

1. Field of the Invention

The present invention is related to a classifier generating apparatus and a classifier generating method, for generating classifiers having tree structures for performing multi class multi view classification of objects. The present invention is also related to a program that causes a computer to execute the classifier generating method.

2. Description of the Related Art

Conventionally, correction of skin tones in snapshots photographed with digital cameras by investigating color distributions within facial regions of people, and recognition of people who are pictured in digital images obtained by digital video cameras of security systems, are performed. In these cases, it is necessary to detect regions (facial regions) within digital images that correspond to people's faces. For this reason, various techniques for detecting faces from within digital images have been proposed. Among these techniques, there is a known detecting method that employs appearance models constructed by a machine learning technique. The detecting method that employs appearance models employs a plurality of linked weak classifiers which are obtained by learning a great number of sample images by machine learning. Therefore, this method is robust and superior in detection accuracy.

The detecting method that employs appearance models will be described as a technique for detecting images within digital images. In this method, features of faces are learned by employing a face sample image group consisting of a plurality of sample images of different faces, and a non face sample image group consisting of a plurality of sample images which are known not to be of faces, as learning data to generate classifiers capable of judging whether an image is an image of a face. Then, partial images are sequentially cut out from an image in which faces are to be detected (hereinafter, referred to as “detection target image”), and the aforementioned classifiers are employed to judge whether the partial images are of faces. Finally, the regions of the detection target image corresponding to the partial images which are judged to be faces are extracted, to detect faces within the detection target image.

Not only forward facing faces, but images in which faces are rotated along the plane of the image (hereinafter, referred to as “in plane rotation”) and images in which faces are rotated within the plane of the image (hereinafter, referred to as “out of plane rotation”) are input to the classifiers. In the case that learning is performed using learning data that include faces of a variety of orientations (faces in multiple views), it is difficult to realize a general use classifier capable of detecting faces in all orientations. For example, the rotational range of faces that a single classifier is capable of classifying is limited to approximately 30 degrees for in plane rotated images, and approximately 30 to 60 degrees for out of plane rotated images. For this reason, classifiers for faces are constituted by a plurality of strong classifiers for respectively discriminating faces in each of a plurality of orientations, in order to efficiently extract statistical features of faces, which are detection targets. Specifically, multi class classifying methods have been proposed, in which a plurality of strong classifiers, which have performed multi class learning to enable classification of images in each orientation, are prepared. Next, all of the strong classifiers are caused to perform classification regarding whether images are faces in specific orientations. Then, it is judged whether the images represent faces, from the ultimate outputs of each of the strong classifiers.

The techniques disclosed in U.S. Patent Application Publication Nos. 20090116693 and 20090157707 and Japanese Unexamined Patent Publication No. 2006-251955 have been proposed as multi class classifying methods. Note that here, descriptions will be given regarding faces as classification targets, in order to simplify explanations of the techniques. In addition, a class C1 including leftward facing faces, a class C2 including forward facing faces, and a class C3 including rightward facing faces will be described as three classes of faces to be classified.

First, the technique disclosed in U.S. Patent Application Publication No. 20090116693 will be described. In this technique, strong classifiers are independently constructed for each class. That is, strong classifiers H^{C1}, H^{C2}, and H^{C3}, respectively constituted by weak classifiers hᵢ^{C1}, hᵢ^{C2}, and hᵢ^{C3}, are generated for each of classes C1 through C3 by a boosting learning method, as illustrated in FIG. 22. Note that learning of each class is performed using two classes of learning data. For example, when constructing the strong classifier for class C1, positive teacher data and negative teacher data with respect to class C1 are employed to perform learning by boosting. At this time, the m weak classifiers at the leading ends of the strong classifiers for classes C1 through C3 are root portions of tree structures, as illustrated in FIG. 23. During classification of input patterns, the weak classifiers at the root portions of classes C1 through C3 calculate scores Hₘ^{C1}, Hₘ^{C2}, and Hₘ^{C3}, which represent intermediate classification results. The intermediate classification results are utilized to determine branching conditions. In FIG. 23, the index of the class in which the highest score is calculated is designated as a branching condition, and a branching destination is determined. Note that the collection of weak classifiers of the strong classifiers generated for each of classes C1 through C3, excluding the first m weak classifiers, are the branches of the tree structure.

Next, the technique disclosed in U.S. Patent Application Publication No. 20090157707 will be described. In the technique disclosed in U.S. Patent Application Publication No. 20090157707, the root portion of a tree structure is constituted by classifiers for classifying faces and non faces. The characteristic features of the technique disclosed in U.S. Patent Application Publication No. 20090157707 are that classes C1 through C3 are not distinguished at the root portion of the tree structure as illustrated in FIG. 24, and that learning for classifying faces and non faces is performed. Filters that react respectively to each of classes C1 through C3 are generated following the root of the tree structure, and the reaction results of the filters are utilized to determine a branching destination. Note that learning of classifiers following branching is performed without utilizing the results prior to the branching. In addition, the filters are constructed by learning using a machine learning method. Further, the branching timing (that is, the position at which branching is performed), branching conditions, and the number of branches following the branching are determined during design of the classifiers. Note that it is possible to construct branches in which a plurality of classes coexist following branching. In addition, it is possible to construct classifiers having a plurality of branches, by repeated branching.

The technique disclosed in Japanese Unexamined Patent Publication No. 2006-251955 will be described. In the technique disclosed in Japanese Unexamined Patent Publication No. 2006-251955, multi class, multi view classifiers are constructed employing the Ada Boost. MH, LogitBoost, or the Joint Boost learning algorithm, for example. FIG. 25 illustrates the structure of a classifier constructed employing the Joint Boost learning algorithm. This structure differs from those disclosed in U.S. Patent Application Publication Nos. 20090116693 and 20090157707 in that no clear branches are present within the classifier structure. Note that the Joint Boost learning algorithm reduces the total number of weak classifiers and improves the classification performance of classifiers, by causing weak classifiers to be shared among classes (refer to A. Torralba et al., “Sharing Visual Features for Multiclass and Multiview Object Detection”, Proceedings of the IEEE Computer Society Conference on Computer Vision and Pattern Recognition (CVPR), pp. 762-769, 2004).

However, the techniques of U.S. Patent Application Publication Nos. 20090116693 and 20090157707 and Japanese Unexamined Patent Publication No. 2006-251955 exhibit the following problems. That is, the technique disclosed in U.S. Patent Application Publication No. 20090116693 is easy to execute because learning for each class is performed individually, but it is necessary to reduce the number of m weak classifiers for each class at the root portion of the tree structure, in order to obtain high detection speed. However, detection accuracy deteriorates if the number of weak classifiers at the root portion is small. Conversely, if the number of weak classifiers at the root portion of the tree structure is increased, the detection speed deteriorates. In addition, there are many cases in which clear borders among each class are not present. Depending on how learning data that represent the borders among classes are handled during independent learning of strong classifiers for each class, flexible branching to perform classification becomes impossible. In addition, because learning is performed independently for the strong classifiers of each class, the amount of calculations for calculating features during pattern classification becomes great. Further, it is difficult to construct classifiers having tree structures with a great number of branches.

In the technique disclosed in U.S. Patent Application Publication No. 20090157707, it is possible to construct classifiers having tree structures with a great number of branches. However, it is difficult to appropriately design branching timings and branching structures. In addition, the classification performance of the classifiers is dependent on the knowledge and experience of designers, and therefore if the design is not appropriate, classification accuracy and classification speed deteriorate. In addition, because classifiers are constructed by trial and error, a long amount of time is necessary for learning. It is often the case that the filters for determining branching destinations are individually constructed for each class. In such cases, because the correlations among classes are not utilized, the amount of calculations for constructing the filters also becomes great. Further, the learning results prior to branching cannot be passed on following branching, because the characteristics of the classes change greatly after branching (that is, because weighting of learning data prior to and following branching is not connected seamlessly). Therefore, the classifying performance of the classifiers as a whole deteriorates.

In the technique disclosed in Japanese Unexamined Patent Publication No. 2006-251955, classes perform learning in common. Therefore, correlations among the classes can be maximally utilized. However, because no clear branches are present, it is necessary to perform classification using all weak classifiers of each class to ultimately obtain classification results. As a result, a long time is required for classifying calculations. High detection speed and execution of real time detection are demanded in applications for detecting faces and people from within images and videos. Therefore, it is preferable for classifiers to be of tree structures having a great number of branches. However, sharing of features among classes in the Joint Boost learning algorithm is sharing of weak classifiers themselves. Accordingly, discriminating performance among classes is low, and it is not possible to satisfy branching requirements of tree structures.

### SUMMARY OF THE INVENTION

The present invention has been developed in view of the foregoing circumstances. It is an object of the present invention to solve the problem related to tree structures of classifiers when generating classifiers for performing multi class, multi view classification, to generate high performance classifiers that realize both classification accuracy and high classification speed.

A classifier generating apparatus of the present invention generates classifiers, which are combinations of a plurality of weak classifiers, for discriminating objects included in detection target images by employing features extracted from the detection target images to perform multi class discrimination including a plurality of classes regarding the objects, and is characterized by comprising:

learning means, for determining branching positions and branching structures of the weak classifiers of the plurality of classes, according to the learning results of the weak classifiers in each of the plurality of classes.

The “weak classifiers” are classifiers that judge whether features obtained from images represents objects, in order to classify the objects.

The “branching structures” include branching conditions and the number of branching destinations. The branching conditions are conditions that determine how learning data are branched and how features are shared among classes after branching. Specifically, in the case that there are five classes as illustrated in FIG. 26, learning is performed in common in all of classes one through five up to a branching position. However, after the branching position, multi class learning is divided into classes one and two, and classes three through five. Branching conditions may be set such that these two branching destinations perform learning employing shared features.

Note that in the classifier generating apparatus of the present invention, the learning means may perform learning of the weak classifiers of the plurality of classes, sharing only the features.

In the Joint Boost learning algorithm, not only the features, but weak classifiers, more specifically, classifying mechanisms that define how classification is performed within the weak classifiers, are shared among classes. “Learning . . . sharing only the features” differs from the Joint Boost learning algorithm, and shares only the features, not the classifying mechanisms of the weak classifiers.

The classifier generating apparatus of the present invention may further comprise:

learning data input means, for inputting a plurality of positive and negative learning data for the weak classifiers to perform learning for each of the plurality of classes; and

filter storage means, for storing a plurality of filters that extract the features from the learning data. In this case, the learning means extracts the features from the learning data using filters selected from those stored in the filter storage means, and performs learning using the extracted features.

The “filters that extract the features” are those that define the positions of pixels which are employed to calculate features within images, the method for calculating features using the pixel values of pixels at these positions, and the sharing relationship of features among classes.

In the classifier generating apparatus of the present invention, the learning means may perform labeling with respect to all of the learning data to be utilized for learning according to degrees of similarity to positive learning data of classes to be learned, to stabilize learning.

In the classifier generating apparatus of the present invention, the learning means may perform learning by:

defining a total sum of weighted square errors of the outputs of weak classifiers at the same level in the plurality of classes with respect to the labels and input features;

defining the total sum of the total sums for the plurality of classes as classification loss error; and

determining weak classifiers such that the classification loss error becomes minimal.

In the classifier generating apparatus of the present invention, the learning means may be a means for calculating the classification loss error of the weak classifiers of each of the plurality of classes at levels for which judgments are made regarding whether branching is to be performed, and for determining the weak classifiers of these levels as branching positions when the amount of change from the classification loss error of an upper level and that of these levels is less than or equal to a predetermined threshold value.

When all positive learning data for each class are branched by branching structures, positive learning data for a certain class should be branched to the branching destination that the class belongs to. However, there are cases in which the positive learning data for the class will be branched to a branching destination other than that of the class. This may occur due to the multi class classifiers' performance up to the branching timing being insufficient to correctly classify all of the learning data because the patterns of the learning data are complex, because fluctuations in the learning data are great and effective features cannot be found, or because the properties of filters and learning data are not matched. This may occur also due to the branching conditions of the branching structure being inappropriate. In these cases, it is preferable for the learning data, which are branched to branching destinations that the class does not belong to, to not be used for learning after branching in order to improve learning accuracy. Accordingly, the learning data, which are branched to branching destinations that the class does not belong to, are lost by branching. Here, the percentage of lost learning data may be calculated by subtracting the percentage of the number of positive learning data which are branched to the branching destination that the class belongs to with respect to the number of positive learning data for the class from 1. “Classification loss error” may be calculated as a weighted integrated value of the percentages of lost learning data for all of the classes obtained by the branching structure. Note that branching structures that will result in the classification error loss becoming minimal are selected from among a pool of branching structures that include utilizable branching structures to determine the branching portions of the classifiers having tree structures, in order to maximize the performance of the classifiers (that is, the classification speed and the classification accuracy).

The classifier generating apparatus of the present invention may further comprise:

storage means, for storing a plurality of branching structures which are determined in advance. In this case, the learning means is a means for selecting branching structures from among the plurality of branching structures such that branching loss errors become minimal at levels for which judgments are made regarding whether branching is to be performed.

In the classifier generating apparatus of the present invention, the learning means may inherit the learning results prior to branching for learning of the weak classifiers following the branching.

A classifier generating method of the present invention generates classifiers, which are combinations of a plurality of weak classifiers, for discriminating objects included in detection target images by employing features extracted from the detection target images to perform multi class discrimination including a plurality of classes regarding the objects, and is characterized by comprising:

a learning step, for determining branching positions and branching structures of the weak classifiers of the plurality of classes, according to the learning results of the weak classifiers in each of the plurality of classes.

A program of the present invention is characterized by causing a computer to execute the functions of the classifier generating apparatus of the present invention.

The present invention determines the branching positions and the branching structures of weak classifiers of a plurality of classes according to the results of learning of the weak classifiers in each class. For this reason, the branching positions and the branching structures of the weak classifiers during multi class learning does not depend on the designer. As a result, classification of objects can be performed accurately and at high speeds using the generated classifiers. In addition, the occurrence of learning not converging will decrease compared to cases in which branching positions and branching structures are determined by designers, and as a result, the converging properties of learning can be improved.

In addition, learning results prior to branching may be inherited for learning of the weak classifiers following the branching. In this case, the weak classifiers are seamlessly connected prior to and following branching. Therefore, the consistency of classifying structures can be maintained in classifiers generated by the present invention. Accordingly, both classification accuracy and high classification speed can be realized.

### BRIEF DESCRIPTION OF THE DRAWINGS

FIG. 1 is a block diagram that illustrates the schematic structure of a classifier generating apparatus according to an embodiment of the present invention.

FIG. 2 is a diagram that illustrates learning data for m+1 classes.

FIGS. 3A and 3B are diagrams that illustrate examples of learning data.

FIG. 4 is a diagram that illustrates an example of a filter.

FIG. 5 is a conceptual diagram that illustrates the processes performed by the classifier generating apparatus according to the embodiment of the present invention.

FIG. 6 is a diagram that illustrates the results of labeling of learning data in the case that there are eight classes.

FIG. 7A is a diagram that schematically illustrates a multi class classifier having a tree structure, constructed by the embodiment of the present invention.

FIG. 7B is a diagram that schematically illustrates weak classifiers of the classifier of FIG. 7A.

FIG. 8 is a flow chart that illustrates a learning process.

FIG. 9 is a graph that illustrates the relationship between the number t of weak classifiers and classification loss error J_{wse} for weak classifiers of four classes.

FIG. 10 is a diagram that illustrates an example of a branching structure.

FIG. 11 is a diagram that illustrates examples of branching structures for three classes.

FIG. 12 is a diagram for explaining calculation of branching loss error.

FIG. 13 is a diagram that illustrates an example of a branching structure for five classes.

FIG. 14 is a diagram that illustrates the numbers of pieces of positive learning data for each class prior to branching.

FIG. 15 is a diagram that illustrates the numbers of pieces of positive learning data for each class which are branched into each leaf node.

FIG. 16 is a diagram that illustrates learning data which are utilized in each leaf node after branching.

FIG. 17 is a diagram that illustrates classifiers which are generated when learning is completed.

FIG. 18 is a diagram that illustrates an example of a histogram.

FIG. 19 is a diagram that illustrates quantization of a histogram.

FIG. 20 is a diagram that illustrates an example of a generated histogram.

FIG. 21 is a diagram that illustrates the relationship between input to a decision tree and outputs.

FIG. 22 is a first diagram for explaining the multi class classifying technique disclosed in U.S. Patent Application Publication No. 20090116693.

FIG. 23 is a second diagram for explaining the multi class classifying technique disclosed in U.S. Patent Application Publication No. 20090116693.

FIG. 24 is a diagram for explaining the multi class classifying technique disclosed in U.S. Patent Application Publication No. 20090157707.

FIG. 25 is a diagram for explaining the multi class classifying technique disclosed in U.S. Patent Application Publication No. 20090157707.

FIG. 26 is a diagram for explaining setting of branching conditions.

### DESCRIPTION OF THE PREFERRED EMBODIMENTS

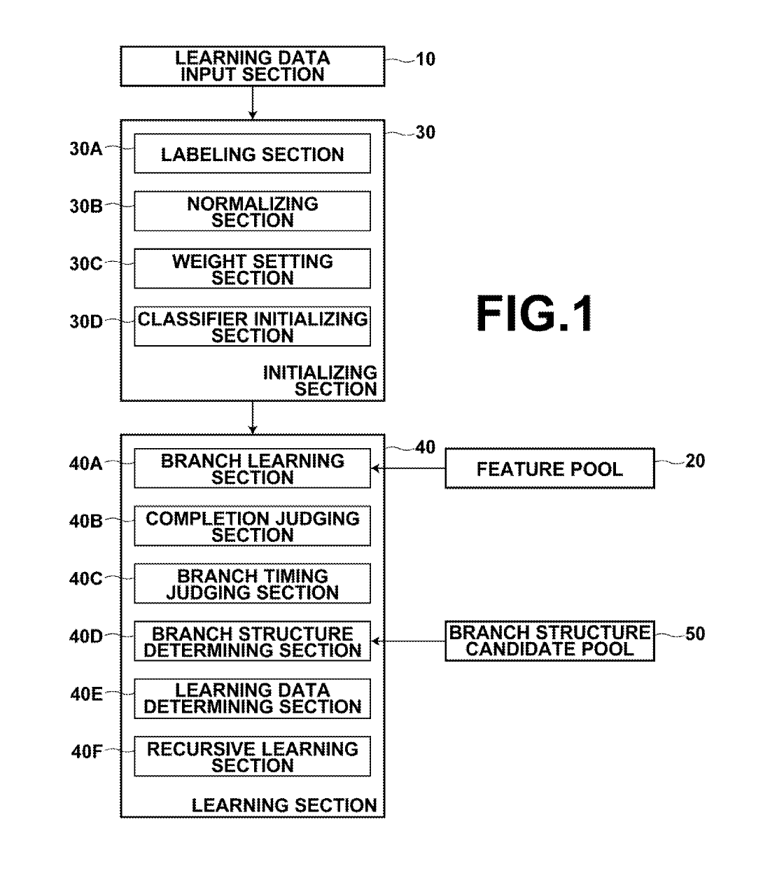

Hereinafter, embodiments of the present invention will be described with reference to the attached drawings. FIG. 1 is a block diagram that illustrates the schematic structure of a classifier generating apparatus 1 according to an embodiment of the present invention. As illustrated in FIG. 1, the classifier generating apparatus 1 of the present invention is equipped with: a learning data input section 10; a feature pool 20; an initializing section 30; a learning section 40; and a branching structure candidate pool 50.

The learning data input section 10 inputs learning data to be utilized for classifier learning into the classifier generating apparatus 1. Here, the classifiers which are generated by the present embodiment are those that perform multi class classification. For example, in the case that the classification target object is a face, the classifiers are those that perform multi class classification to classify faces which have different orientations along the plane of the image and different facing directions within the images. Accordingly, the classifier generating apparatus 1 of the present invention generates m classes of classifiers, each capable of classifying faces of a different orientation. For this reason, the learning data input section 10 inputs different learning data xᵢ^{Cu} (i=1−N_{Cu}, u=1−m, and N_{Cu} is the number of pieces of learning data corresponding to each class Cu), that is, learning data in which the orientations and facing directions of faces are different, into the classifier generating apparatus 1. Note that in the present embodiment, the learning data are image data, in which the sizes and the positions of feature points (such as eyes, noses, etc.) are normalized.

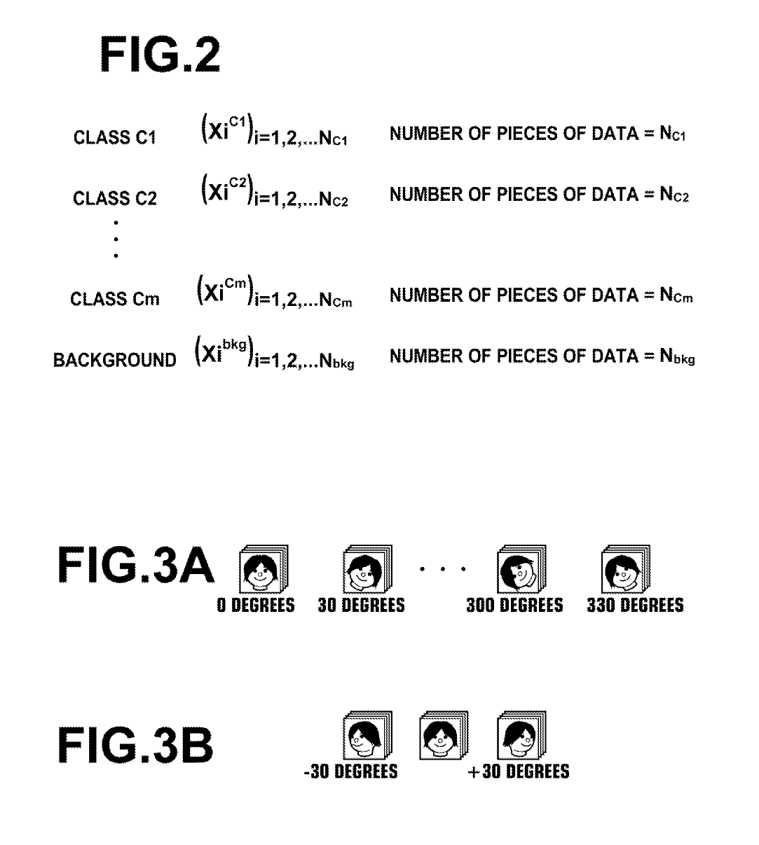

In addition, learning data xᵢ^{bkg} (number of data N_{bkg}) that represent backgrounds that do not belong to any class of the classification target object are also input into the classifier generating apparatus 1 of the present embodiment. Accordingly, learning data for m+1 classes as illustrated in FIG. 2 are input and utilized to generate classifiers.

FIGS. 3A and 3B are diagram that illustrate examples of learning data. Note that FIGS. 3A and 3B illustrate learning data to be utilized for classifiers that classify faces. As illustrated in FIGS. 3A and 3B, the learning data are of a predetermined image size, and include twelve types of in plane rotated images (FIG. 3A), in which faces positioned at a set position (the center, for example) within the images are rotated in 30 degree increments, and three types of out of plane rotated images (FIG. 3B), in which faces are positioned at a set position within the images are facing directions of 0 degrees, −30 degrees, and +30 degrees. By preparing learning data in this manner, 12·3=36 class classifiers are generated. Note that the classifiers of each class are constituted by a plurality of linked weak classifiers.

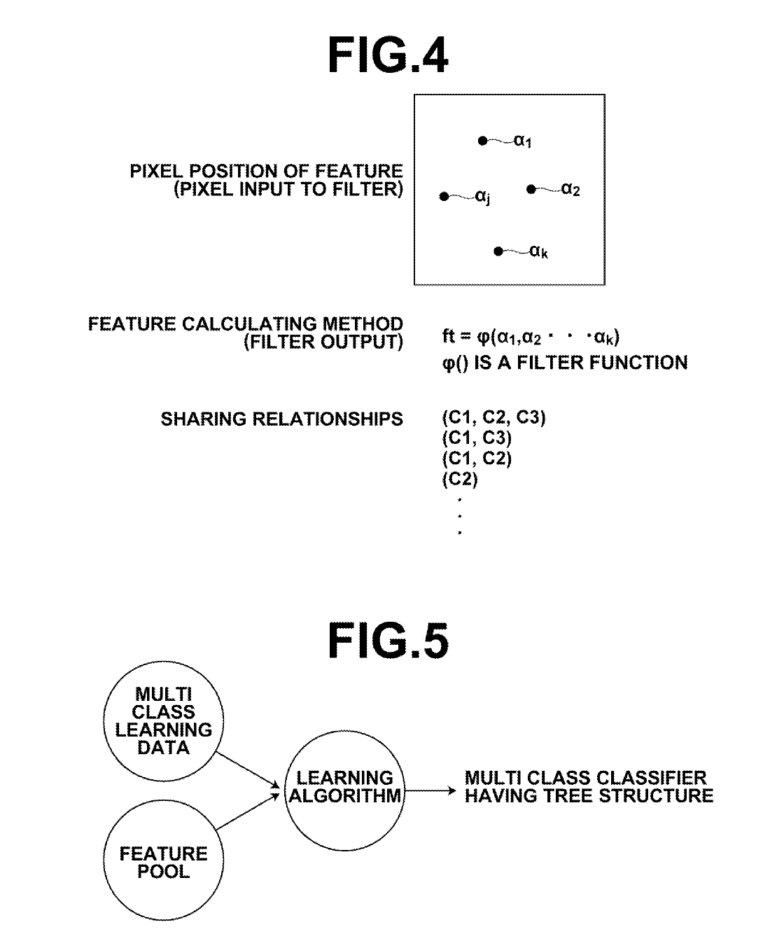

A plurality of filters ft, for extracting features to be employed to judge whether classification target image data belong in a certain class from the learning data, are stored in the feature pool 20. The filters ft define the positions of pixels which are employed to calculate features within the learning data, the method for calculating features using the pixel values of pixels at these positions, and the sharing relationship of features among classes. FIG. 4 is a diagram that illustrates an example of a filter. The filter ft illustrated in FIG. 4 obtains pixel values (α1 through αk) of k points or k blocks which are determined advance within classification target image data, and defines that calculations are to be performed using a filter function p among the pixel values obtained for al through ak. Note that the pixel values al through ak are input to the filter ft, and the calculation results of the filter function p are output by the filter ft. With respect to the sharing relationship of features, in the case that there are three classes C1 through C3, there will be seven types of sharing relationships, (C1, C2, C3), (C1, C2), (C1, C3), (C2, C3), (C1), (C2), and (C3). It is preferable for the filters ft to be defined such that a great number of classes can share the filters ft, in view of search times for sharing relationships during learning, and efficient generation of multi class classifiers. Note that the sharing relationships maybe defined such that features are shared among all classes. The learning data and the filters ft within the feature pool 20 are defined and prepared in advance by users.

FIG. 5 is a conceptual diagram that illustrates the processes performed by the classifier generating apparatus 1 according to the embodiment of the present invention. As illustrated in FIG. 5, the present embodiment employs the multi class learning data and the filters ft of the feature pool 20 with respect to the classification target object to perform learning by a learning algorithm that only shares features, which is the characteristic feature of the present embodiment, to generate multi class classifiers having tree structures.

The initializing section 30 performs the processes of labeling learning data, normalizing the number of pieces of learning data, setting weighting for learning data, and initializing classifiers. Hereinafter, each of the processes performed by the initialing section 30 will be described. Note that the initializing section 30 includes: a labeling section 30A for labeling learning data; a normalizing section 30B for normalizing the number of pieces of learning data; a weight setting section 30C for setting weighting for learning data; and a classifier initializing section 30D for initializing classifiers. First, labeling of learning data will be described. Labeling of learning data is performed to indicate whether pieces of learning data belong to a learning target class during learning of weak classifiers for each class. As shown below, labels for all classes are set for each piece of learning data xᵢ^{C}. Note that setting labels for all classes clarifies whether each piece of learning data xᵢ^{C} (belonging to class C) is to be treated as positive teacher data or negative teacher data during learning of each class Cu. Whether each piece of learning data is to be treated as positive teacher data or negative teacher data is determined by the labels.

xᵢ^{C}→(zᵢ^{C1}, zᵢ^{C2}, . . . , zᵢ^{Cm})

Here, assuming that C∈ [C1, C2, . . . , Cm, bkg], in the case that C=Cu (u=1 through m, that is, learning data are not background images), the labeling section 30A of the initializing section 30 sets the value of the label to +1 (zᵢ^{Cu}=+1). Conversely, in the case that C=bkg (that is, learning data are background images), the value of the label is set to −1 (zᵢ^{Cbkg}=−1). In addition, in the case that the learning data are not background images, the values of labels are set further, as described below. In cases that the class of the weak classifier which is a learning target and the class of a piece of learning data does not match, for example, a case in which the class of the learning target weak classifier is C1, and the class of a piece of learning data to be utilized for the learning is C3 (a piece of learning data xᵢ^{C3}, for example), the value of the label is set according to the degree of similarity within the class of the learning data for the learning target weak classifier and the learning data of different classes. For example, in cases that the class of the learning target weak classifier and the classes of the learning data are similar, such as a case in which the class of the learning target weak classifier is C3 and the classes of the learning data are C2 or C4, the values of labels are set to 0 (zᵢ^{Cu}=0). Conversely, in cases that the class of the learning target weak classifier and the classes of the learning data are not similar, such as a case in which the class of the learning target weak classifier is C3 and the classes of the learning data are C1 or C6, the values of labels are set to −1 (zᵢ^{Cu}=−1). Note that pieces of learning data having labels valued +1 are positive teacher data, and pieces of learning data having labels valued −1 are negative teacher data.

Note that judgments regarding whether learning data of a class (designated as Ca) for a learning target weak classifier and learning data of another class (designated as Cb) are similar are performed based on the appearance spaces thereof. That is, if an appearance space represented by class Cb is adjacent to or partially overlaps an appearance space represented by class Ca, it is judged that the data of class Cb are similar to the data of class Ca. In cases that an appearance space represented by class Cb is not adjacent to or does not partially overlaps an appearance space represented by class Ca, it is judged that the data of class Cb are not similar to the data of class Ca.

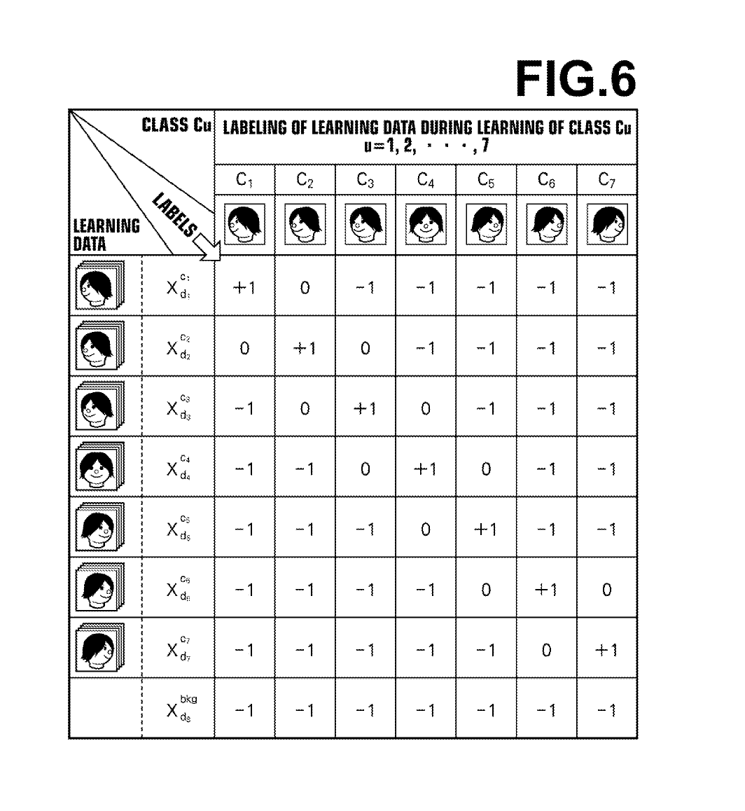

It is necessary to perform learning for seven classes, each of which are assigned faces having different facing directions in 20 degree increments, from a leftward facing face in profile to a rightward facing face in profile, in order to detect faces and to classify the facing directions thereof. The results of labeling for learning data for such a case are illustrated in FIG. 6. As illustrated in FIG. 6, classes C1 through C7 each correspond to different facing directions, but there are no clear boundaries among adjacent classes. For this reason, in the case that the class of a learning target weak classifier is C3, the values of labels zᵢ^{C3} for learning data of class C3 are set to +1, the values of labels zᵢ^{C2} and zᵢ^{C4} for learning data of adjacent classes C2 and C4 are set to 0, and the values of labels for learning data of all other classes are set to −1. Accordingly, in the present embodiment, the values of the labels zᵢ^{Cu} assume the three values of −1, 0, and +1. By setting the labels as described above, the stability of learning of the weak classifiers of the classes Cu using the learning data xᵢ^{C} can be improved.

Note that judgments regarding whether learning data are similar to each other may alternatively be performed by calculating correlations among the learning data of the classes, and judging that the learning data are similar if the correlation is a predetermined value or higher. As a further alternative, users may judge whether learning data of different classes are similar, by manual operations.

Next, the normalizing process for the number of pieces of learning data performed by the normalizing section 30 will be described. As described above, learning data are prepared for each class. However, there are cases in which the numbers of pieces of learning data differ among classes. In addition, in the classifier generating apparatus 1 of the present embodiment, learning data of classes having labels zᵢ^{Cu} valued +1 and −1 with respect to the classes of learning target weak classifiers are employed for learning, and learning data of classes having labels zᵢ^{Cu} valued 0 are weighted as 0 and are not utilized, as will be described later. Here, learning data having labels zᵢ^{Cu} valued +1 with respect to a certain class Cu are employed as positive learning data, and learning data having labels zᵢ^{Cu} valued −1 are employed as negative learning data. If the number of pieces of positive learning data is designated as N+^{Cu} and the number of pieces of negative learning data is designated as N−^{Cu} for a certain class Cu, the number of pieces of learning data N_{tchr}^{Cu} for the class Cu can be expressed as N+^{Cu}+N−^{Cu}.

In the present embodiment, the numbers of pieces of learning data N_{tchr}^{Cu} for all classes Cu are normalized such that the number of pieces of learning data N_{tchr}^{Cu} for each class is equal to a number ₘᵢₙN_{tchr}^{Cu} of pieces of learning data of a class Cu having the smallest number of pieces of learning data. Note that it is necessary to reduce the number of pieces of learning data for classes other than the class having the smallest number of pieces of learning data ₘᵢₙN_{tchr}^{Cu}. At this time, randomly selected pieces of learning data from among background learning data xᵢ^{bkg} may be removed from the negative learning data, to reduce the number of pieces of learning data. The number of pieces of learning data N_{tchr}^{Cu} for each class Cu is updated to become the normalized number of pieces of learning data, and the normalizing process with respect to the learning data is completed.

Next, the weight setting process administered on the learning data will be described by the weight setting section 30C. Weighting refers to weighting of the learning data during learning of the weak classifiers of each class Cu. As shown below, weighting values for m classes are set for each piece of learning data xᵢ^{C}.

xᵢ^{C}→wᵢ(wᵢ^{C1}, wᵢ^{C2}, . . . , wᵢ^{Cm})

Here, assuming that C∈ [C1, C2, . . . , Cm, bkg] weighting values wᵢ^{Cu} are set with respect to pieces of learning data xᵢ^{Cu} within a class Cu, based on the values of the labels zᵢ^{Cu} thereof. Specifically, weighting wᵢ^{Cu} is set as 1/(2N+^{Cu}) for positive learning data having labels zᵢ^{Cu} with values of +1 for a certain class Cu, set as 1/(2N−^{Cu}) for positive learning data having labels zᵢ^{Cu} with values of −1 for the class Cu, set as 0 for positive learning data having labels zᵢ^{Cu} with values of 0 for the class Cu. Accordingly, the learning data having labels valued 0 are not utilized for learning of the class Cu. Note that N+^{Cu} is the number of pieces of positive learning data within a class Cu, and N−^{Cu} is the number of negative pieces of negative learning data within a class Cu.

Note that the classifier initializing section 30D initializes the classifiers of the classes Cu such that the number of weak classifiers is 0 for each class. That is, the classifiers are initialized such that no weak classifiers are present, by setting the initial values of each classifier to 0 (H^{C1}, H^{C1}, . . . , H^{Cm}=0).

The learning section 40 includes: a branch learning section 40A, a completion judging section 40B, a branch timing judging section 40C, a branch structure determining section 40D, a learning data determining section 40E, and a recursive learning section 40F. Hereinafter, the learning processes performed by the learning section 40 will be described. The multi class classifiers which are generated by the present embodiment are those in which a plurality of weak classifiers hₜ^{Cu} (t=1−n, n is the number of weak classifier steps) which are linked to have tree structures (that is, H^{Cu}=Σhₜ^{Cu}).

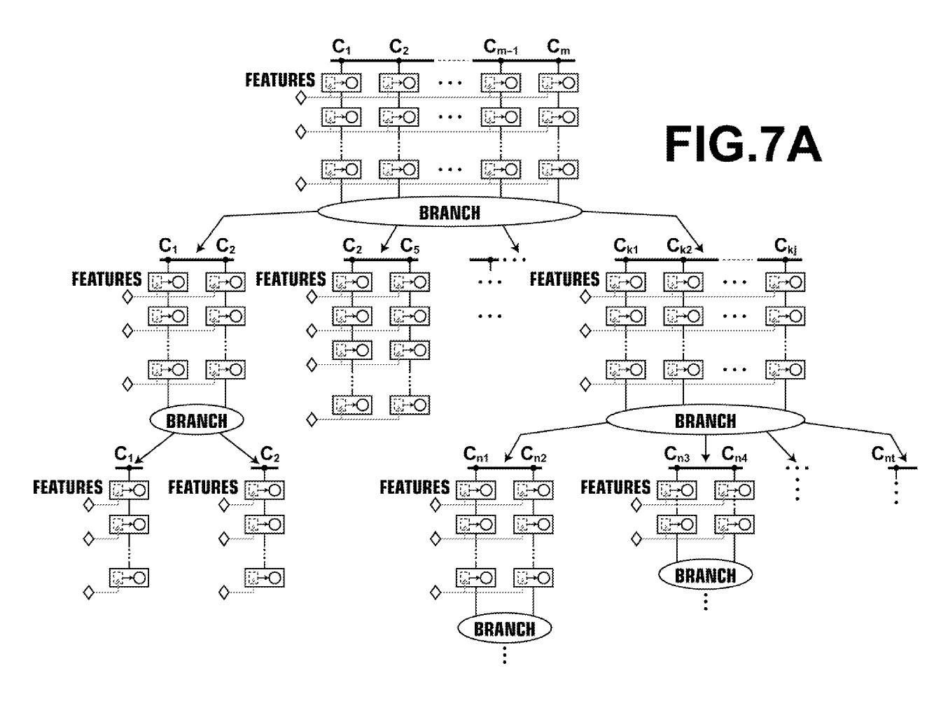

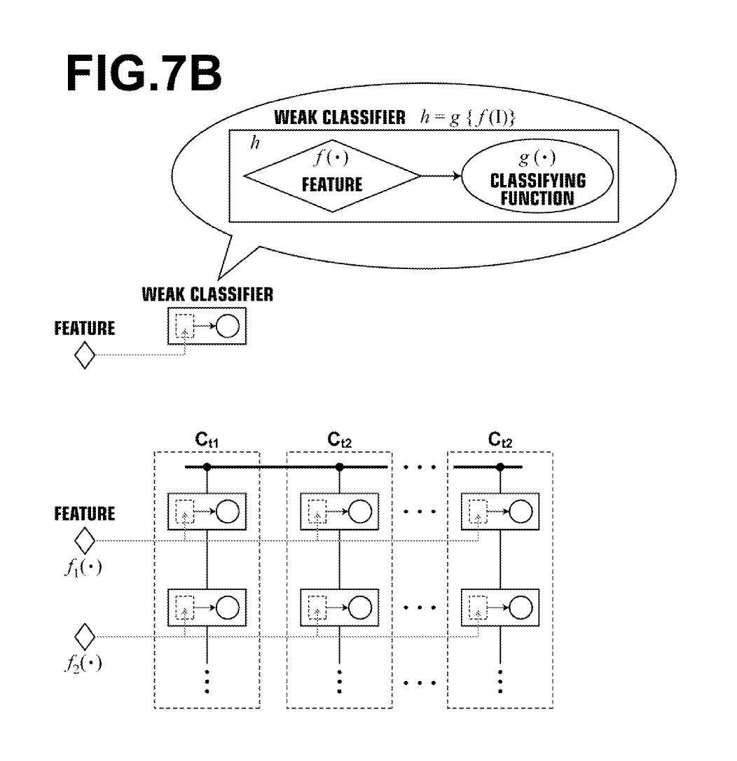

FIG. 7A is a diagram that schematically illustrates such a multi class classifier having a tree structure. The multi class classifier of FIG. 7A is of a tree structure, in which a classifier of a single class has a plurality of classification routes. A single classification route is a classifier (strong classifier) of the class. The branches of the tree structure determine which classification route unknown input data to be classified will travel through. In addition, the classifiers of each class Cu are constituted by a plurality of weak classifiers. Features are shared among the weak classifiers of the tree structure. FIG. 7B is a diagram that schematically illustrates weak classifiers. As illustrated in FIG. 7B, the weak classifier is represented by h=g{f(I)} (g is a classifying function, and f(I) is a feature of unknown data I). The classifier of the present embodiment differs from conventional classifiers in that features are shared, that classifying functions differ for each class, and as a result, the weak classifiers of each class are different.

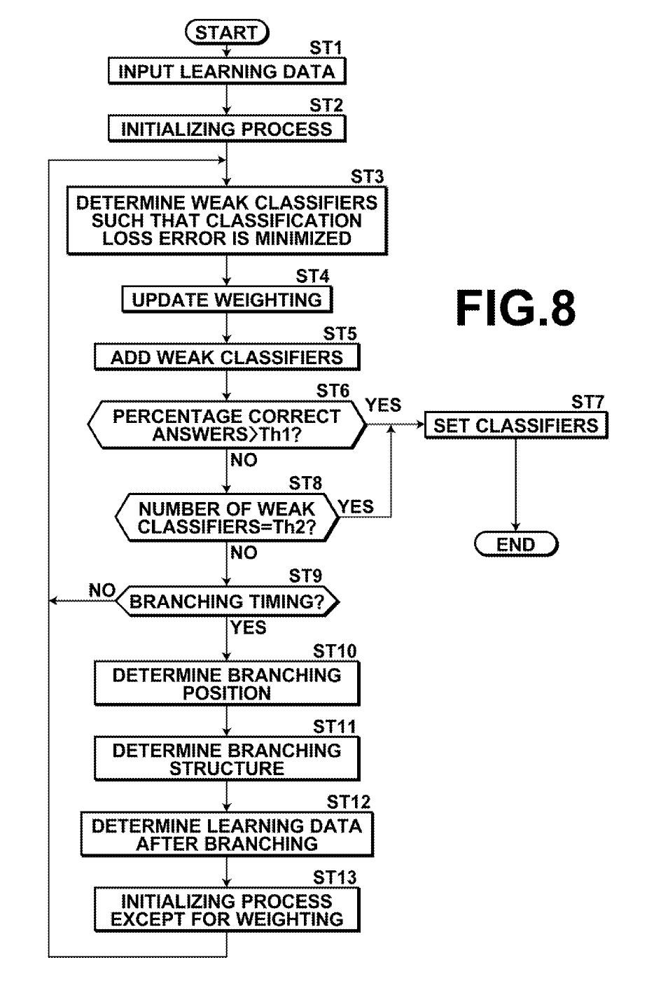

FIG. 8 is a flow chart that illustrates the steps of a learning process. Note that the process illustrated in FIG. 8 is performed for all branches that constitute the tree structure of the classifiers, but the portion prior to branching is the root. First, the learning data input section 10 inputs learning data to be utilized for learning into the classifier generating apparatus 1 (step ST1). Next, the initializing section performs the initialization processes (step ST2). The initializing processes include labeling of the learning data, normalization of the number of pieces of learning data, setting the weighting of the learning data, and initialization of the classifiers. Meanwhile, the learning performed by the learning section 40 is initiated by the branch learning section, by determining weak classifiers hₜ^{Cu} of each step of the classifier in each class. First, the branch learning section 40A. First, the branch learning section 40A of the learning section 40 selects a filter ft arbitrarily from among the feature pool 20. Then, the selected filter ft is employed to extract features ft (xᵢ) for all classes included in the branch (or the root) from all pieces of the learning data xᵢ. Here, if classifying mechanisms for calculating scores for classification from the features ft (xᵢ) within the weak classifiers hₜ^{Cu} are designated as gₜ^{Cu}, the process that the weak classifiers hₜ^{Cu} perform using the features can be represented as hₜ^{Cu}(xᵢ)=gₜ^{Cu}(ft(xᵢ). Note that hₜ^{Cu}(xᵢ) represents scores which are output by weak classifiers hₜ^{Cu} regarding learning data, of which the features are extracted by the selected filter ft.

In the present embodiment, histogram type classifying functions are utilized as classifying mechanisms. Weak classifiers are determined by generating histograms that determine scores with respect to the values of features obtained from the learning data. In the classifying mechanisms of histogram type classifying functions, the probability that an object is the object of a classification target class increases as the score is greater in the positive direction, and probability that an object is not the object of a classification target class increases as the score is greater in the negative direction.

Here, the purpose of learning is to determine weak classifiers. For this reason, the learning section 40 employs the labels zᵢ^{Cu} and weights wᵢ^{Cu} of the learning data xᵢ of each class and defines weighted square errors of the labels zᵢ^{Cu} and the scores as loss error, to determine the weak classifiers. The learning section defines a total sum of loss errors for all pieces of learning data xᵢ in this manner. For example, the amount of loss error J^{C1} for class C1 may be defined by Formula (1) below. Note that in Formula (1), Ntchr is the total number of pieces of learning data.

$$\begin{matrix}{J}^{C 1} = {{w}_{1}^{C 1} ( {z}_{1}^{C 1} - {h}_{t}^{C 1} ( {x}_{1} ) )}^{2} + {w}_{2}^{C 1} {( {z}_{2}^{C 1} - {h}_{t}^{C 1} ( {x}_{2} ) )}^{2} + \\ {{w}_{3}^{C 1} ( {z}_{3}^{C 1} - {h}_{t}^{C 1} ( {x}_{3} ) )}^{2} ++ {w}_{Ntchr} ( {z}_{Ntchr} - {h}_{t}^{C 1} ( {x}_{Ntchr} ) ) \\ = {\sum }_{i = 1}^{Ntchr} {{w}_{i}^{C 1} ( {z}_{i}^{C 1} - {h}_{i}^{C 1} ( {x}_{i} ) )}^{2}\end{matrix} \qquad ( 1 )$$

Then, the branch learning section 40A defines the total sum of loss errors J^{Cu} for all classes within each branch (or the root) as classification loss error J_{wse} according to Formula (2) below. Note that Formula 2 is a formula for calculating classification loss error in cases that the degree of importance for each class being learned is the same. In the case that the degree of importance of the classes being learned are different, the degree of importance for each class in Formula (2) may be weighted. Classification loss error, in which weighting is performed with respect to the degrees of importance, can be calculated by Formula (2′).

$$\begin{matrix}\begin{matrix}{J}_{wse} = {\sum }_{i = 1}^{Ntchr} {{w}_{i}^{C 1} ( {z}_{i}^{C 1} - {h}_{i}^{C 1} ( {x}_{i} ) )}^{2} + {\sum }_{i = 1}^{Ntchr} {{w}_{i}^{C 2} ( {z}_{i} - {h}_{t}^{C 2} ( {x}_{i} ) )}^{2} ++ \\ {\sum }_{i = 1}^{Ntchr} {{w}_{i}^{Cm} ( {z}_{i} - {h}_{t}^{Cm} ( {x}_{i} ) )}^{2} \\ = {\sum }_{u = 1}^{m} {\sum }_{i = 1}^{Ntchr} {{w}_{i}^{Cu} ( {z}_{i}^{Cu} - {h}_{t}^{Cu} ( {x}_{i} ) )}^{2}\end{matrix} & ( 2 ) \\ \begin{matrix}{J}_{wse} = {\tilde{a}}_{C 1} {\sum }_{i = 1}^{Ntchr} {{w}_{i}^{C 1} ( {z}_{i}^{C 1} - {h}_{t}^{C 1} ( {x}_{i} ) )}^{2} + \\ {\tilde{a}}_{C 2} {\sum }_{i = 1}^{Ntchr} {{w}_{i}^{C 2} ( {z}_{i} - {h}_{i}^{C 2} ( {x}_{i} ) )}^{2} ++ {\tilde{a}}_{Cm} {\sum }_{i = 1}^{Ntchr} {{w}_{i}^{Cm} ( {z}_{i} - {h}_{t}^{Cm} ( {x}_{i} ) )}^{2} \\ = {\sum }_{u = 1}^{m} {\tilde{a}}_{Cu} {\sum }_{i = 1}^{Ntchr} {{ù}_{i}^{Cu} ( {z}_{i}^{Cu} - {h}_{t}^{Cu} ( {x}_{i} ) )}^{2}\end{matrix} & ( {2}^{′} )\end{matrix}$$

wherein γ_{C1}, γ_{C2}, γ_{Cm}, are weights (degrees of importance) for classes C1, C2, . . . Cm, respectively.

Next, the branch learning section 40A determines weak classifiers hₜ^{Cu} such that the classification loss error J_{wse} becomes minimal (Step ST3). In the present embodiment, the classifying mechanisms are histogram type classifying functions. Therefore, weak classifiers hₜ^{Cu} are determined by generating histograms to determine scores with respect to features obtained from learning data. Note that the method by which the weak classifiers hₜ^{Cu} are determined will be described later. After the weak classifiers hₜ^{Cu} are determined in this manner, the weights wᵢ^{Cu} of the learning data xᵢ^{Cu} are updated as shown in Formula (3) below (step ST4). Note that the updated weights wᵢ^{Cu} are normalized as shown in Formula (4) below. In Formula (3), hₜ^{Cu} represents scores output by the weak classifiers with respect to the learning data xᵢ^{Cu}.

$$\begin{matrix}{w}_{i}^{Cu} = {w}_{i}^{Cu} ( old ) \cdot {e}^{- {zi}^{Cu} \cdot {ht}^{Cu}} & ( 3 ) \\ {w}_{i}^{Cu} ( new ) = \frac{{w}_{i}^{Cu}}{{\sum }_{i = 1}^{Ntchr} {w}_{i}^{Cu}} & ( 4 )\end{matrix}$$

Here, in the case that the score output by a weak classifier hₜ^{Cu} with respect to a piece of learning data is positive, the probability that the learning data is an object is the object of a classification target class is high, and if the score output by a weak classifier hₜ^{Cu} with respect to a piece of learning data is negative, the probability that the learning data is an object is the object of a classification target class is low. For this reason, if scores are positive for pieces of learning data having labels hₜ^{Cu} valued +1, the weighting wᵢ^{Cu} is updated to become smaller, and if scores are negative, the weighting wᵢ^{Cu} is updated to become greater. Meanwhile, if scores are positive for pieces of learning data having labels hₜ^{Cu} valued −1, the weighting wᵢ^{Cu} is updated to become greater, and if scores are negative, the weighting wᵢ^{Cu} is updated to become smaller. This means that if a weak classifier hₜ^{Cu} classifies a piece of positive learning data and the score output thereby is positive, the weighting of the piece of learning data is updated to become smaller, and if the score output by the weak classifier hₜ^{Cu} is negative, the weighting of the piece of learning data is updated to become greater. Likewise, if a weak classifier hₜ^{Cu} classifies a piece of negative learning data and the score output thereby is positive, the weighting of the piece of learning data is updated to become greater, and if the score output by the weak classifier hₜ^{Cu} is negative, the weighting of the piece of learning data is updated to become smaller.

Weak classifiers hₜ^{Cu} are determined for each class of each branch (or root), and the weights wᵢ^{Cu} are updated in this manner. Thereafter, the branch learning section 40A adds newly determined weak classifiers hₜ^{Cu} to previously determined weak classifiers (step ST5). Note that in a first process, there are no weak classifiers in the classes. Therefore, weak classifiers hₜ^{Cu} for the first step of each class are added in the first process. Newly determined weak classifiers are added thereafter, in a second and subsequent processes.

After new weak classifiers hₜ^{Cu} are added to each class in this manner, the completion judging section 40B judges whether to complete learning. Specifically, it is judged whether the percentage of correct answers of a combination H^{Cu}=Σhₜ^{Cu} of n weak classifiers hₜ^{Cu} which have been determined up to that point exceeds a predetermined threshold value Th1 (step ST6). That is, the weak classifiers hₜ^{Cu} which have been determined up to that point are combined and utilized to classify positive learning data for each class. It is judged whether the percentage of results of classification that match the correct answers as to whether the pieces of learning data actually represent the object of the classification target class exceeds the threshold value Th1. In cases that the percentage of correct answers exceeds the predetermined threshold value Th1, the classification target object can be classified with a sufficiently high probability by using the weak classifiers hₜ^{Cu} which have been determined up to that point. Therefore, the classifiers are set for the classes (step ST7), and the learning process is completed.

In contrast, if the percentage of correct answers is the threshold value Th1 or less, the completion judging section 40B judges whether the current number of weak classifiers hₜ^{Cu} within each class has reached a predetermined threshold value Th2 (step ST8). If the number of weak classifiers hₜ^{Cu} has reached the predetermined threshold value Th2, the process proceeds to step ST7, the classifiers are set for the classes (step ST7), and the learning process is completed, because if the number of weak classifiers hₜ^{Cu} is increased further, the learning process and the classifying process by the classifiers will require long amounts of time.

In the case that the number of weak classifiers hₜ^{Cu} has not reached the threshold value Th2, the branch timing judging section 40C of the learning section 40 judges whether learning has reached a branching timing (step ST9). Specifically, the branch timing judging section 40C calculates a difference ΔJ_{wse} between classification loss error J_{wse} calculated by determined weak classifiers hₜ^{Cu} and classification loss error J_{wse-1} calculated by weak classifiers hₜ^{Cu} determined in a previous process for all classes. Then, the branch timing judging section 40C judges whether a branching timing has been reached, based on whether the difference ΔJ_{wse} is less than a predetermined threshold value Th3 for all classes.

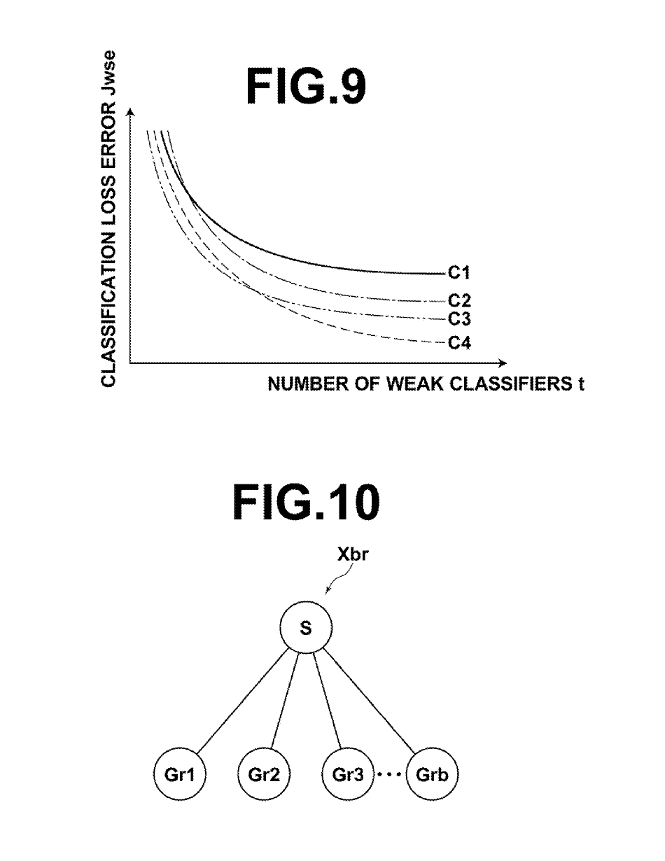

Here, in the learning process of the present embodiment, the number of weak classifiers increases as learning proceeds, and classification loss error decreases accompanying the increase in the number of weak classifiers. FIG. 9 is a graph that illustrates the relationship between the number t of weak classifiers and classification loss error J_{wse} for weak classifiers of classes C1 through C4. As illustrated in FIG. 9, the classification loss error J_{wse} decreases greatly as the number t of weak classifiers hₜ^{Cu} increases during the initial stages of learning, when the number t of weak classifiers hₜ^{Cu} is small. However, as learning progresses, the amount of decrease in the classification loss error J_{wse} with respect to increases in the number t of weak classifiers hₜ^{Cu} decreases. Here, that the amount of decrease in the classification loss error is small decreases means that there is no significant improvement in the classification performance, even if the number of weak classifiers hₜ^{Cu} is increased further.

For this reason, the branch timing judging section 40C judges whether a branching timing has been reached, based on whether the difference ΔJ_{wse} is less than a predetermined threshold value Th3 for all classes Cu included in each branch (or root). In the case that the difference ΔJ_{wse} is less than the predetermined threshold value Th3 for all classes Cu, the positions of the weak classifiers hₜ^{Cu} determined up to that point are set as branching positions (step ST10). Next, the branch structure determining section 40D determines the branching structures at the branching positions (step ST11). The manner in which the branching structures are determined will be described later. After the branching structures are determined, the learning data determining section 40E of the learning section 40 determines learning data to be utilized for learning by each class Cu after branching (step ST12). The manner in which the learning data to be utilized for learning after branching are determined will also be described later. After the learning data are determined, the recursive learning section 40F causes the initializing section 30 to perform initializing processes other than the weight setting processes, that is, the labeling of learning data, the normalization of the numbers of pieces of learning data, and the initialization of the classifiers, such that the same learning as prior to branching can be performed after branching (step ST13). Then, the recursive learning section 40F returns to step ST3 and repeats the steps of the process therefrom, to perform learning that shares features in each branch which is a branching destination and to determine additional weak classifiers hₜ^{Cu} to link the branching destinations with the weak classifiers hₜ^{Cu} which were determined prior to branching. In this case, the weights wᵢ^{Cu} which have been set already are utilized. Note that the filters ft which are employed for second and subsequent learning steps are arbitrarily selected. Therefore, there are cases in which the same filter ft is selected again before learning is completed.

Note that in the case that it is judged at step ST9 that a branching timing has not been reached, that is, in the case that the difference in loss errors ΔJ_{wse} for all classes is not less than the threshold value Th3, the process returns to step ST3 and learning is repeated, to determine additional weak classifiers hₜ^{Cu} to be linked with weak classifiers hₜ^{Cu} which have already been determined. N this case as well, the filters ft which are employed for second and subsequent learning steps are arbitrarily selected. Therefore, there are cases in which the same filter ft is selected again before learning is completed.

The determined weak classifiers hₜ^{Cu} are linked linearly in the order that they are determined. In addition, score tables are generated for calculating scores according to features, based on histograms with respect to each weak classifier hₜ^{Cu}. Note that the histograms themselves may be employed as the score tables. In this case, the classification points of the histograms become the scores. The multi class classifiers are generated by performing learning of classifiers for each class in this manner.

Next, the process by which the branch structure determining section 40D determines branching structures will be described. In the present embodiment, the branching structures define branching conditions and the number of branching destinations. Branching conditions are conditions that determine how the learning data are branched among classes of the branching destinations following branching, and how the features are to be shared. The branching structure candidate pool 50 has a plurality of branching structure candidates that define various branching conditions and numbers of branching destinations for classifiers. FIG. 10 is a diagram that illustrates an example of a branching structure. As illustrated in FIG. 10, a branching structure Xbr is constituted by a branching node S and a plurality (a number b) of leaf nodes Gr1 through Grb. The branching node S defines branching conditions regarding which leaf node from among the leaf nodes Gr1 through Grb input learning data are to be branched to. Note that learning that shares features after branching is performed by the leaf nodes Gr1 through Grb. Leaning that shares different features is performed among the leaf nodes Gr1 through Grb.

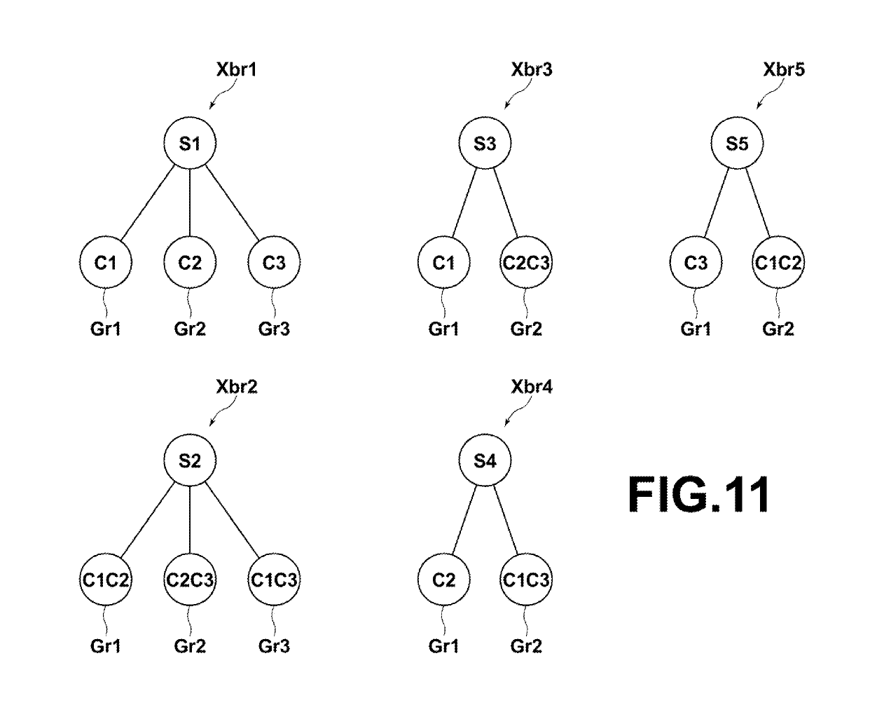

FIG. 11 is a diagram that illustrates examples of branching structures for three classes. Note that the five types of branching structures illustrated in FIG. 11 are merely examples, and it goes without saying that various other types of branching structures may be adopted. In FIG. 11, branching nodes are denoted by reference numerals S1 through S5, and leaf nodes Gr1 through Gr3 are represented as combinations of classes C1 through C3. Branching structure Xbr1 of FIG. 11 defines branching conditions, in which each class performs learning by sharing different features after branching. Branching structure Xbr2 defines branching conditions, in which classes C1 and C2, classes C2 and C3, and classes C1 and C3 perform learning sharing features. Branching structure Xbr3 defines branching conditions, in which classes C2 and C3 perform learning sharing features. Branching structure Xbr4 defines branching conditions, in which classes C1 and C3 perform learning sharing features. Branching structure Xbr5 defines branching conditions, in which classes C1 and C3 perform learning sharing features.

Here, how the learning data xᵢ^{Cu} are branched within branching structure Xbr1 will be described in detail. In branching structure Xbr1, scores Scoreₓ^{Cu} (u=1˜3) with respect to a piece of learning data xᵢ^{Cu} are calculated using the weak classifiers of each class which are generated prior to branching. Then, the piece of learning data is branched to the leaf node corresponding to the class in which the calculated score is the highest. For example, in the case that Scoreₓ^{C1} assumes the highest value, the piece of learning data is branched into leaf node Gr1. In addition, how the learning data xᵢ^{Cu} are branched within branching structure Xbr2 will be described in detail. In branching structure Xbr2, scores Scoreₓ^{Cu} (u=1˜3) with respect to apiece of learning data xᵢ^{Cu} are calculated using the weak classifiers of each class which are generated prior to branching. Then, the scores are ranked, and the piece of learning data is branched to the leaf node corresponding to the two classes having the top two rankings. For example, in the case that Scoreₓ^{C1} and Scoreₓ^{C2} assume the two highest values, the piece of learning data is branched into leaf nodes Gr1, which corresponds to classes C1 and C2. In branching structures Xbr3 through Xbr5, scores Scoreₓ^{Cu} (u=1˜3) are calculated and ranked in the same manner as in branching structure Xbr2. Then, the learning data are branched to the leaf nodes corresponding to the class in which the rankings are highest. For example, in branching structure Xbr5, if Scoreₓ^{C3} assumes the highest value, the piece of learning data is branched into leaf node Gr1 which corresponds to Class C3. Meanwhile, if Scoreₓ^{C1} or Scoreₓ^{C2} assumes the highest value, the piece of learning data is branched into leaf node Gr2, which corresponds to classes C1 and C2.

Here, when positive learning data for the classes are branched by branching structures, positive learning data for a certain class are to be branched into the branching destination in which the class belongs. However, in multi class classifiers up to the branching timing, there are cases in which learning data are branched to branching destinations that the classes they correspond to do not belong in. This is caused by reasons, such as not all pieces of learning data are correctly classified, branching conditions of branching structures not being appropriate, etc. In these cases, it is preferable for the erroneously branched pieces of learning data to not be used for further learning after the branching, in order to improve learning accuracy. Accordingly, learning data, which are branched into branching destinations that the classes that they correspond to do not belong in, are lost by branching. In the present embodiment, this loss is defined as branching loss error. The learning section 40 calculates branching loss error as described below.

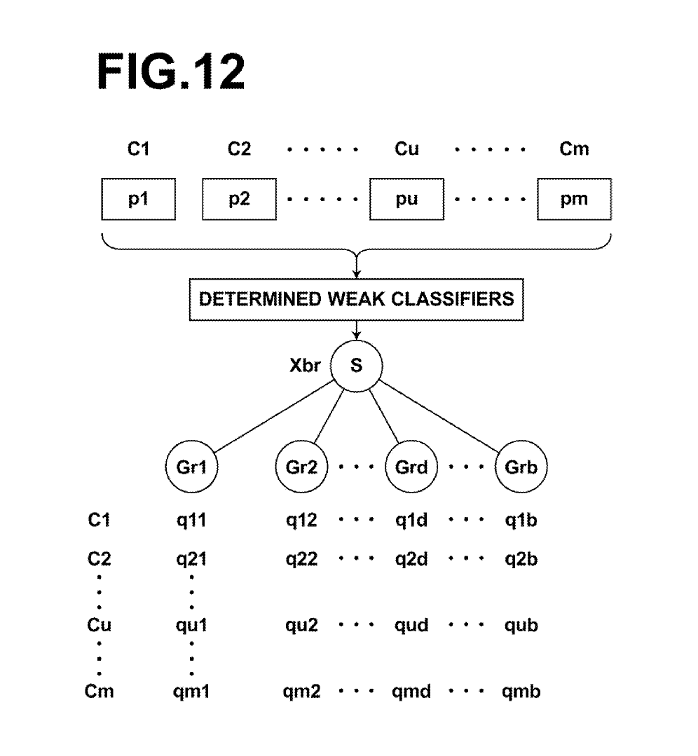

FIG. 12 is a diagram for explaining calculation of branching loss error. Assume that the numbers of pieces of positive learning data for each of classes C1 through Cm are p1 through pm, as illustrated in FIG. 12. The learning section 40 branches the learning data for each class according to a branching structure Xbr, and counts the number of pieces of branched learning data for each of leaf nodes Gr1 through Grb. Here, the number of pieces of learning data for a class Cu which are branched into a leaf node Grd from among the pᵤ pieces of learning data is designated as q_{ud}. Then, the branching loss error BL_{xbr}^{Cu} for class Cu due to branching structure Xbr is calculated by Formula (5) below. Note that the number within the { } in Formula (5) represents the number of pieces of learning data which are branched in the case that class Cu belongs to leaf node Grd. For example, if the class is class C1 and the branching structure is Xbr2 illustrated in FIG. 11, the number of the number of branched pieces of learning data represented within { } of Formula (5) is q11 and q13, which are the numbers of pieces of learning data branched into leaf node Gr1 and leaf node Gr3. In this case, if the number of pieces of learning data for class C1 is 1000, q11 is 400, and q13 is 550, the branching loss error BL_{xbr}^{Cu} is 0.05.

$${BL}_{Xbr}^{Cu} = 1.0 - \frac{{\sum }_{d = 1}^{b} \{ {q}_{ud} \vert Cu is a member of Grd \}}{{p}_{u}} \qquad ( 5 )$$

The branching structure determining section 40D calculates branching loss error BL_{xbr}^{Tchr} for all of the learning data by weighting and adding branching loss errors BL_{xbr}^{Cu} of all of the classes Cu according to Formula (6) below. Note that in Formula (6), w_{BLu} is weighting with respect to branching loss errors BL_{xbr}^{Cu} of each class. Here, the weighting w_{BLu} is set by a designer. For example, in the case that the degrees of importance of the classes being learned are the same, w_{BLu} is set to 1.0. In contrast, in the case that the degrees of importance of the classes being learned are different, the weighting w_{BLu} is set to be greater for a class of forward facing faces than for other classes, for example. The learning section 40 employs all of the branching structures to calculate branching loss error BL_{xbr}^{Tchr} for each branching structure, and determines a branching structure by selecting a branching structure that yields the smallest branching loss error BL_{xbr}^{Tchr}.

$${BL}_{Xbr}^{Tchr} = {\sum }_{u = 1}^{m} {w}_{BLu} \cdot {BL}_{Xbr}^{Cu} \qquad ( 6 )$$

Next, the process by which the learning data determining section 40E determines learning data to be employed after branching will be described. The learning data determining section 40E determines learning data to be utilized by each class in the branching destination leaf nodes Grd. The determination of learning data utilizes the counting results of the numbers of pieces of learning data within each of the leaf nodes Gr1 through Grb. For example, in the case that the branching structure is determined to be branching structure Xbr2 of FIG. 11 and the numbers of pieces of learning data branched to leaf node Gr1 and leaf node Gr3 from among the 1000 pieces of learning data for class C1 are 400 and 550, respectively, the branched 400 pieces of learning data are employed for learning class C1 beyond leaf node Gr1, and the branched 550 pieces of learning data are employed for learning class C1 beyond leaf node Gr3. in this case, the 50 pieces of learning data which were not branched into either leaf node Grd1 or leaf node Gr3 are lost, and will not be utilized for learning following branching.

Leaning that shares features is continued following branching, according to the branching conditions of the determined branching structure.

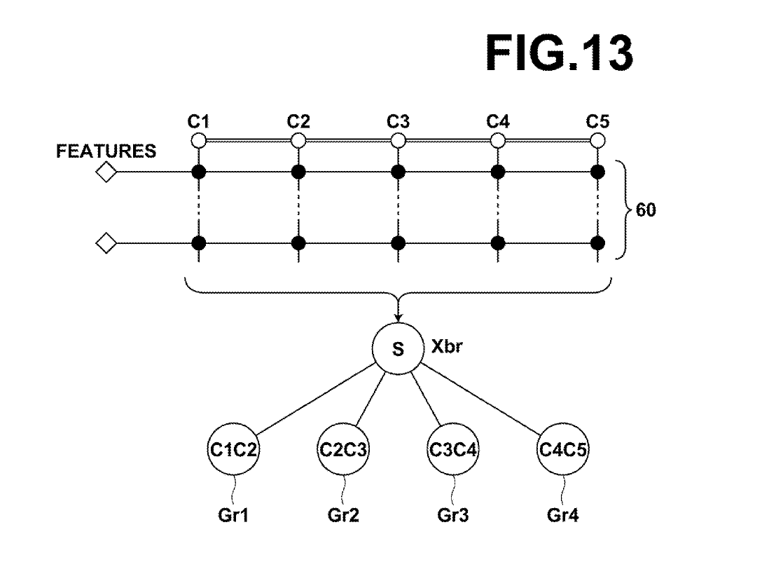

Hereinafter, learning after the branching structure is determined will be described in greater detail. FIG. 13 is a diagram that illustrates an example of a branching structure which have been determined for learning of five classes C1 through C5. As illustrated in FIG. 13, 60 weak classifiers are determined for classes C1 through C5 prior to branching by learning shared features. The determined branching structure Xbr has branching conditions such that classes C1 and C2, Classes C2 and C3, classes C3 and C4, and classes C4 and C5 belong to four leaf nodes Gr1 through Gr4, respectively. For this reason, class C1 belongs to leaf node Gr1, class C2 belongs to leaf nodes Gr1 and Gr2, class C3 belongs to leaf nodes Gr2 and Gr3, class C4 belongs to leaf nodes Gr3 and Gr4, and class C5 belongs to leaf node Gr4.

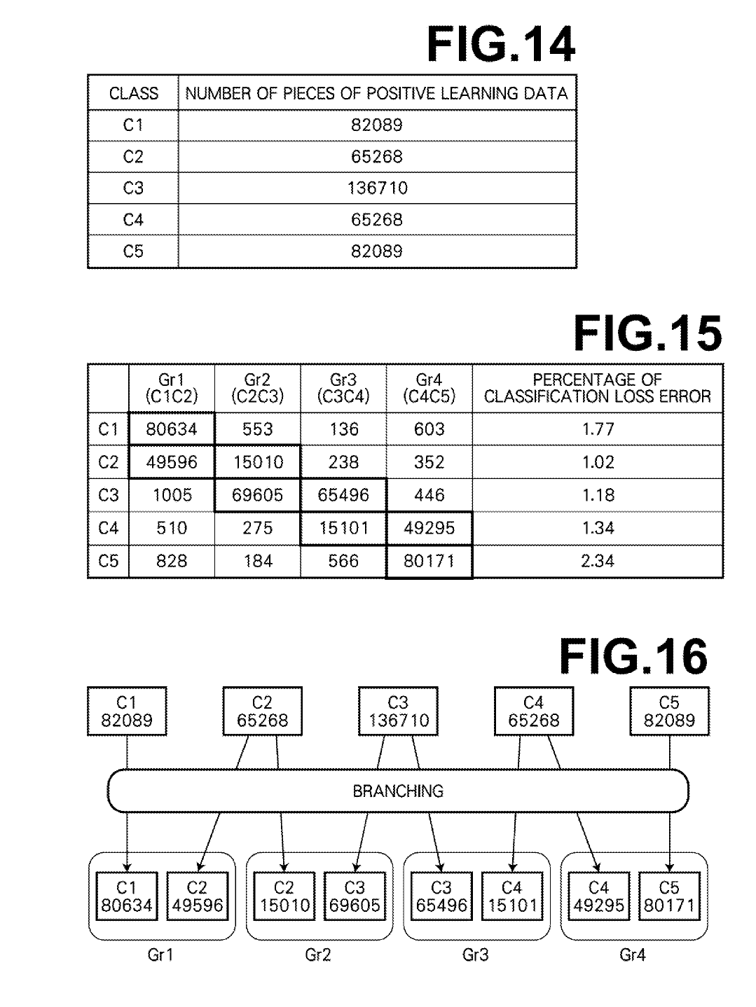

FIG. 14 is a diagram that illustrates the numbers of pieces of positive learning data for each class prior to branching. FIG. 15 is a diagram that illustrates the numbers of pieces of positive learning data for each class which are branched into each of the leaf node Gr1 through Gr4. The blocks outlined by the bold lines in FIG. 15 indicate the numbers of pieces of learning data which are employed for learning within each of leaf nodes Gr1 through Gr4 after branching. The numbers in the other blocks indicate pieces of learning data which are lost due to branching into leaf nodes Gr1 through Gr4, and are not utilized for learning after branching. Accordingly, the numbers of pieces of learning data which are utilized for learning in each of leaf nodes Gr1 through Gr4 after branching are those illustrated in FIG. 16. Note that the background learning data may also be branched into the leaf nodes Gr1 through Gr4 by the determined branching structure, and therefore such background learning data are utilized after branching to determine weak classifiers.

The weak classifiers of classes C1 through C5 illustrated in FIG. 13 which have been determined up to that point are divided by a determined branching structure, and learning that shares features proceeds within each of leaf nodes Gr1 through Gr4.

Note that after branching, the numbers of pieces of learning data are normalized in a similar manner to that performed prior to branching, such that the numbers of pieces of learning data for each class within each of leaf nodes Gr1 through Gr4 become equal. In addition, the classifiers are initialized such that the number of classifiers in each class within each of leaf nodes Gr1 through Gr4 becomes 0. Note that the weighting of the pieces of learning data is not initialized, and the weighting prior to branching is inherited after branching.

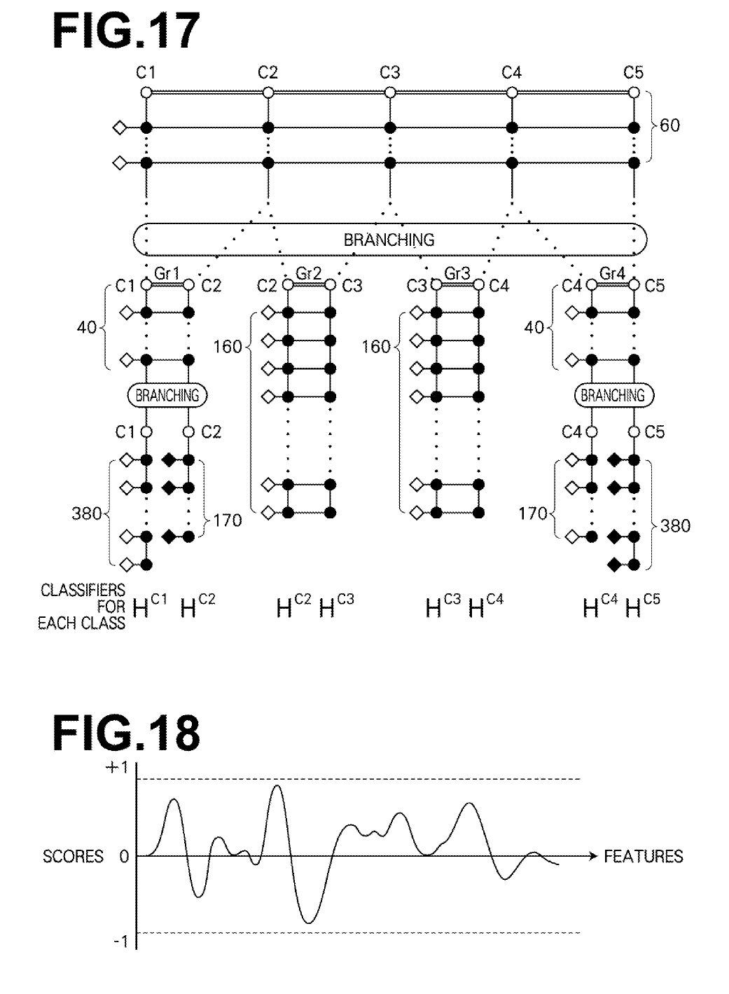

Weak classifiers are determined for each of leaf nodes Gr1 through Gr4 according to the flow chart of FIG. 8 after branching as well. If necessary, further branching is performed and learning is continued. FIG. 17 is a diagram that illustrates classifiers which are generated when learning is completed. As illustrated in FIG. 17, leaf nodes Gr1 and Gr4 are branched after 40 weak classifiers are determined. After branching, leaning using different features for each class is performed, and is completed after 380 weak classifiers are determined for class C1, 170 weak classifiers are determined for class C2, 170 weak classifiers are determined for class C4, and 380 weak classifiers are determined for class C5. With respect to leaf nodes Gr2 and Gr3, these leaf nodes perform learning sharing features, and learning is completed when 160 weak classifiers are determined for each class belonging thereto.

Here, the reason why leaf nodes Gr2 and Gr3 do not branch again is because the results of multi class learning for classes C2 and C3 that shares features have reached desirable classification performance. The classifiers illustrated in FIG. 17 are constituted by a plurality of classifiers, and a plurality of routes are present for classes C2, C3, and C4 due to branching. Therefore, a plurality of corresponding classifiers are present for these classes.

Next, the process by which weak classifiers are determined by the branch learning section 40A will be described. The present embodiment utilizes histogram type classifying functions as classifying mechanisms. FIG. 18 is a diagram that illustrates an example of a histogram type classifying function. As illustrated in FIG. 18, a histogram that functions as a classifying mechanism of a weak classifier hₜ^{Cu} has the values of features as its horizontal axis, and probabilities that an object is the object of a classification target class, that is, scores, as its vertical axis. Note that scores assume values within a range from −1 to +1. In the present embodiment, weak classifiers are determined by generating histograms, more specifically, by determining scores corresponding to each feature within the histograms. Hereinafter, generation of a histogram type classifying function will be described.

In the present embodiment, weak classifiers hₜ^{Cu} are determined by generating histograms which are classifying mechanisms of the weak classifiers hₜ^{Cu}, such that the classification loss error J_{wse} becomes minimal. Here, the weak classifiers hₜ^{Cu} of each step share features. However, a description will be given for a case in which features are not shared among some classes, to describe a general process. Thereby, the classification loss error J_{wse} of Formula (2) can be modified to a sum of loss error J^{share} for classes that share features and loss error J^{unshare} for classes that do not share features, as shown in Formula (7) below. Note that because hₜ^{Cu}(xᵢ)=gₜ^{Cu}(ft(xᵢ)), the values of the horizontal axis of the histogram is substituted as ft(xᵢ)=rᵢ in Formula (7). In Formula (7), the “share” and “unshare” beneath the Σ indicate that a total sum of loss error for classes that share features and a total sum of loss error for classes that do not share features are calculated.

$$\begin{matrix}{J}_{wse} = {\sum }_{u = 1}^{m} {\sum }_{i = 1}^{Ntchr} {{w}_{i}^{Cu} ( {z}_{i}^{Cu} - {h}_{t}^{Cu} ( {x}_{i} ) )}^{2} \\ = {\sum }_{share} {\sum }_{i = 1}^{Ntchr} {{w}_{i}^{Cu} ( {z}_{i}^{Cu} - {g}_{t}^{Cu} ( {r}_{i} ) )}^{2} + \\ {\sum }_{unshare} {\sum }_{i = 1}^{Ntchr} {{w}_{i}^{Cu} ( {z}_{i}^{Cu} - {g}_{t}^{Cu} ( {r}_{i} ) )}^{2} \\ = {J}^{share} + {J}^{unshare}\end{matrix} \qquad ( 7 )$$

In Formula (7), if the values of both loss error J^{share} and loss error J^{unshare} become minimal, a minimal classification loss error J_{wse} can be achieved. For this reason, assuming that the number of classes that share features is k, the loss error J^{share} of classes that share features can be represented by Formula (8) below. Note that in Formula (8), s1 through sk indicate the numerals of classes, which have been renumbered as those that share features, from among the classes of all of the classifiers. In Formula (8), if the items toward the right side of each line are represented as J_{Cs1}^{share} through J_{Cs1}^{share}, Formula (8) may be rewritten as Formula (9).

$$\begin{matrix}\begin{matrix}{J}^{share} = {\sum }_{share} {\sum }_{i = 1}^{Ntchr} {{w}_{i}^{Cu} ( {z}_{i}^{Cu} - {g}_{t}^{Cu} ( {r}_{i} ) )}^{2} \\ = {\sum }_{i = 1}^{Ntchr} {{w}_{i}^{Cs 1} ( {z}_{i}^{Cs 1} - {g}_{t}^{Cs 1} ( {r}_{i} ) )}^{2} + \\ {\sum }_{i = 1}^{Ntchr} {{w}_{i}^{Cs 2} ( {z}_{i}^{Cs 2} - {g}_{t}^{Cs 2} ( {r}_{i} ) )}^{2} ++ \\ {\sum }_{i = 1}^{Ntchr} {{w}_{i}^{Csk} ( {z}_{i}^{Csk} - {g}_{t}^{Csk} ( {r}_{i} ) )}^{2}\end{matrix} & ( 8 ) \\ {J}^{share} = {J}_{Cs 1}^{share} + {J}_{Cs 2}^{share} + … + {J}_{Csk}^{share} & ( 9 )\end{matrix}$$

In Formula (9), if the values of J_{Cs1}^{share} through J_{Cs1}^{share}, which are the items toward the right side of each line of Formula (8) that represent loss errors for classes that share features, become minimal, a minimal classification loss error J^{share} can be achieved. Here, because the calculation for minimizing loss errors J_{Cs1}^{share} through J_{Cs1}^{share} are the same for all classes, a calculation for minimizing loss error J_{Csj}^{share} for a class Csj (j=1˜k) will be described.

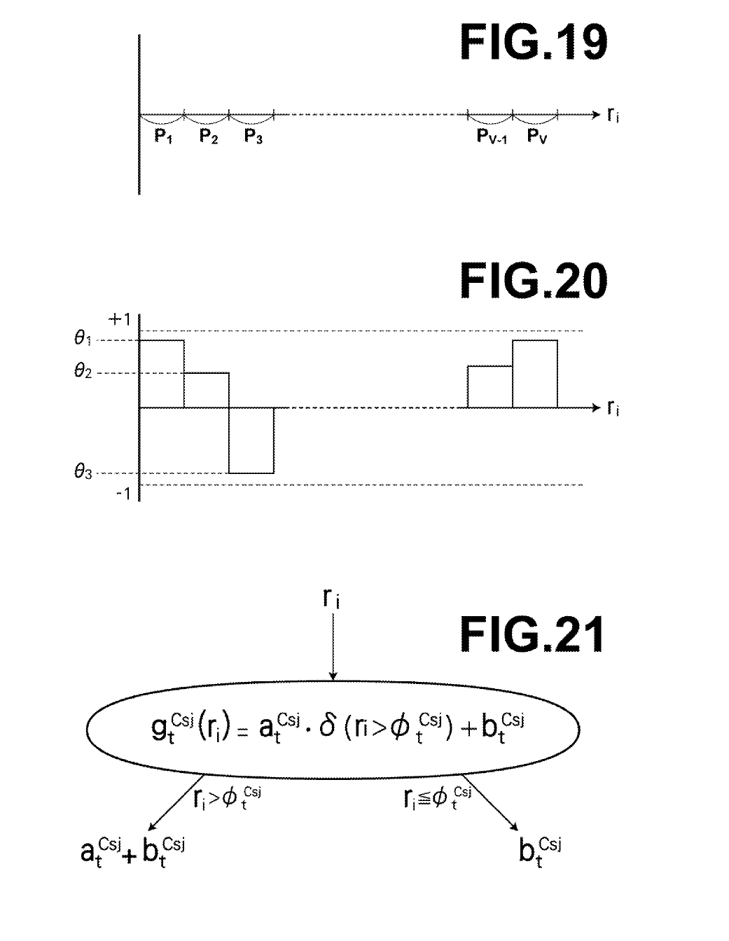

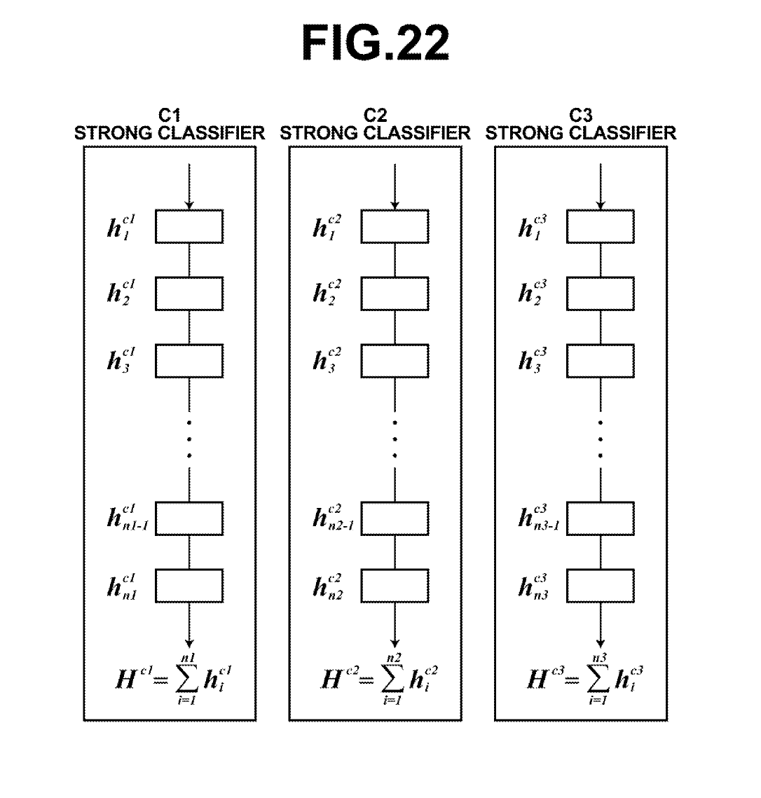

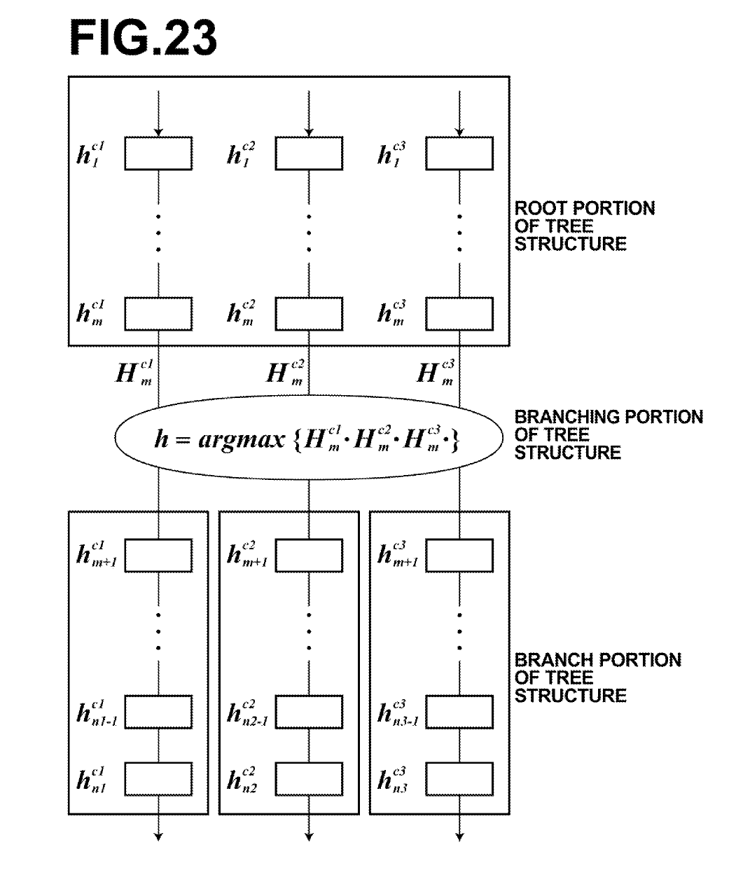

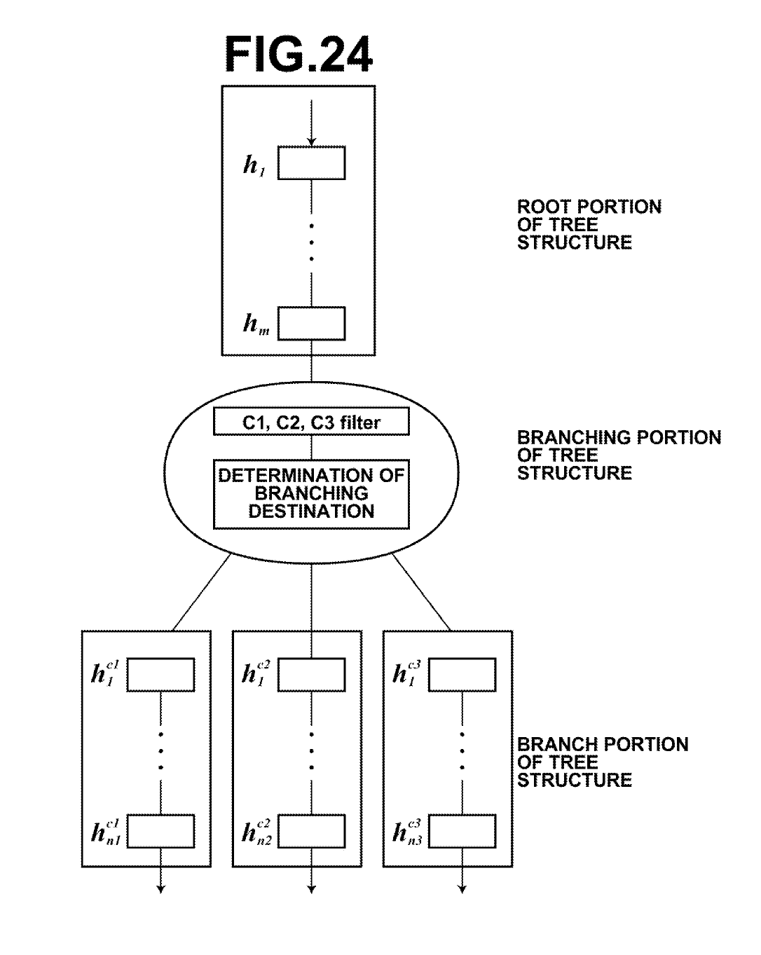

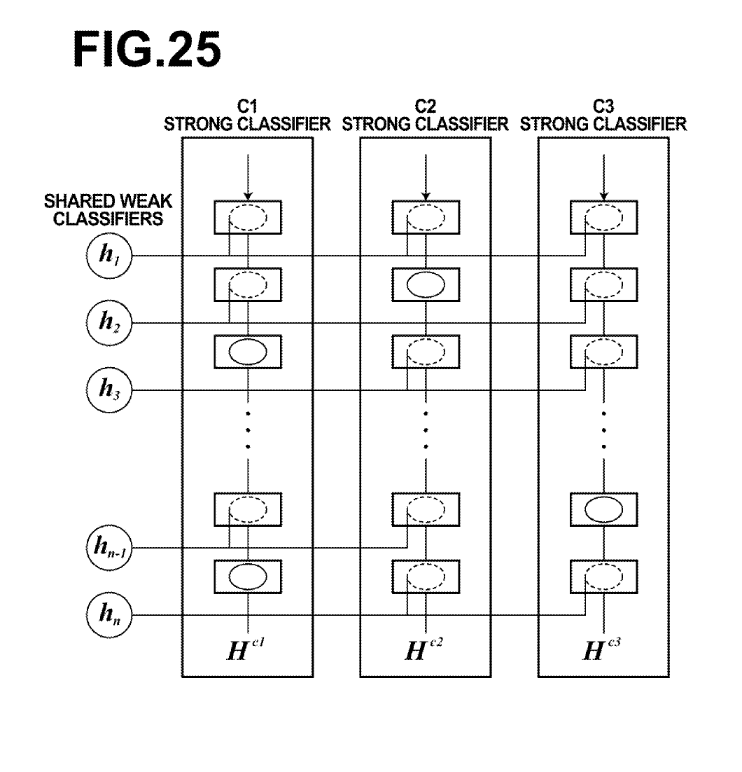

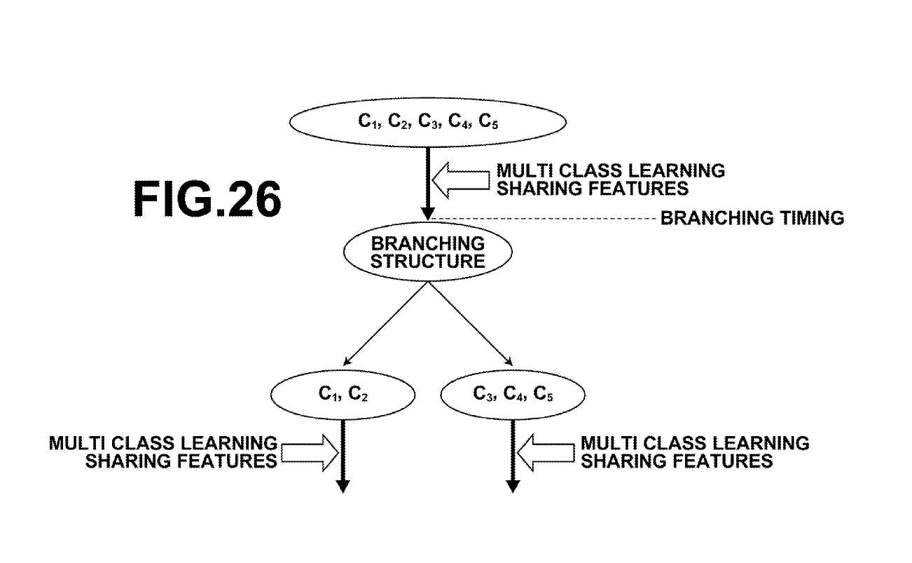

Here, the values that the features can assume are limited to a predetermined range. The present embodiment segments ranges within the horizontal axis of the histogram and quantizes them into sections P1 through Pv (v=100, for example), as illustrated in FIG. 19. The segmentation is performed in order to efficiently express statistical data regarding the features of a great number of pieces of learning data, and in response to requirements with respect to memory, detection speed, and the like when implementing the classifiers. Note that the vertical axis of the histogram is determined by calculating features from all of the learning data, and then calculating statistical data using Formula (13) below. Thereby, the generated histogram reflects statistical data regarding the classification target object, and therefore classification performance is improved. In addition, the amounts of calculation required to generate histograms and during classification can be reduced. The loss error J_{Csj}^{share} is a total sum of loss errors within each section P1 through Pv. Therefore, the loss error J_{Csj}^{share} can be modified as shown in Formula (10) below. Note that rᵢ∈P_{q}(q=1˜v) and the like beneath the Σ indicate that the total sum of loss errors are calculated for cases that features rᵢ belong to sections P_{q}.

$$\begin{matrix}{J}_{csj}^{share} = {\sum }_{i = 1}^{Ntchr} {{w}_{i}^{Csj} ( {z}_{i}^{Csj} - {g}_{t}^{Csj} ( {r}_{i} ) )}^{2} \\ = {\sum }_{{r}_{i} ∈ P 1} {{w}_{i}^{Csj} ( {z}_{i}^{Csj} - {g}_{t}^{Csj} ( {r}_{i} ) )}^{2} + \\ {\sum }_{{r}_{i} ∈ P 2} {{w}_{i}^{Csj} ( {z}_{i}^{Csj} - {g}_{t}^{Csj} ( {r}_{i} ) )}^{2} + … + \\ {\sum }_{{r}_{i} ∈ P v} {{w}_{i}^{Csj} ( {z}_{i}^{Csj} - {g}_{t}^{Csj} ( {r}_{i} ) )}^{2}\end{matrix} \qquad ( 10 )$$

Because the histogram is quantized into sections P1 through PV as illustrated in FIG. 19, the score values gₜ^{Csj} (rᵢ) are constant within each section. Accordingly, gₜ^{Csj} (rᵢ) can be expressed as gₜ^{Csj} (rᵢ)=θ_{q}^{Csj}, and therefore Formula (10) can be modified into Formula (11) below.

$$\begin{matrix}{J}_{Csj}^{share} = {\sum }_{q = 1}^{v} {\sum }_{{r}_{i} ∈ Pq} {{w}_{i}^{Csj} ( {z}_{i}^{Csj} - {g}_{t}^{Csj} ( {r}_{i} ) )}^{2} \\ = {\sum }_{q = 1}^{v} {\sum }_{{r}_{i} ∈ Pq} {{w}_{i}^{Csj} ( {z}_{i}^{Csj} - {θ}_{q}^{Csj} )}^{2}\end{matrix} \qquad ( 11 )$$

Here, the values of labels zᵢ^{Csj} in Formula (11) are either +1 or −1. Accordingly, (zᵢ^{Csj}θ_{q}^{Csj}) is either (1−θ_{q}^{Csj}) or (−1−θ_{q}^{Csj}). Accordingly, Formula (11) can be modified into Formula (12) below.

$$\begin{matrix}{J}_{Csj}^{share} = {\sum }_{q = 1}^{v} {\sum }_{{r}_{i} ∈ Pq} {{w}_{i}^{Csj} ( {z}_{i}^{Csj} - {è}_{q}^{Csj} )}^{2} \\ = {\sum }_{q = 1}^{v} \{ {( 1 - {è}_{q}^{Csj} )}^{2} \cdot {w}_{q}^{Csj +} + {( 1 - {è}_{q}^{Csj} )}^{2} \cdot {w}_{q}^{Csj -} \}\end{matrix} \\ wherein \\ {w}_{q}^{Csj +} = {\sum }_{{r}_{i} ∈ {P}_{q} , {z}_{i}^{Csj} = 1} {w}_{i}^{Csj} , {w}_{q}^{Csj -} = {\sum }_{{r}_{i} ∈ {P}_{q} , {z}_{i}^{Csj} = 1} {w}_{i}^{Csj} \qquad ( 12 )$$

If the value calculated by Formula (12) becomes minimal, the loss error J_{Csj}^{share} will become minimal. The value of θ^{Csj} may be determined for each section Pq such that the value calculated by Formula (12) partially differentiated by θ_{q}^{Csj} becomes 0. Accordingly, θ_{q}^{Csj} can be calculated by Formula (13) below.

$$\frac{\partial {J}_{Csj}^{share}}{\partial {θ}_{q}^{Csj}} = 0 \\ ∴ - 2 ( 1 - {θ}_{q}^{Csj} ) \cdot {w}_{q}^{Csj +} - 2 ( - 1 - {θ}_{q}^{Csj} ) \cdot {w}_{q}^{Csj -} = 0 \\ ∴ {θ}_{q}^{Csj -} = \frac{{w}_{q}^{Csj +} - {w}_{q}^{Csj -}}{{w}_{q}^{Csj +} + {w}_{q}^{Csj -}} \qquad ( 13 )$$

Here, W_{q}^{Csj+} is the total sum of weights wᵢ^{Csj} with respect to pieces of learning data xᵢ having labels valued 1, that is, positive learning data xᵢ, within sections Pq of the histogram. W_{q}^{Csj}⁻ is the total sum of weights wᵢ^{Csj} with respect to pieces of learning data xᵢ having labels valued ¥1, that is, negative learning data xᵢ, within sections Pq of the histogram. Because the weights wᵢ^{Csj} are known, w_{q}^{Csj+} and W_{q}^{Csj-} can be calculated, and accordingly, the vertical axis of the histogram for sections Pq, that is, the scores θ_{q}^{Csj}, can be calculated by Formula (13) above.

The weak classifiers hₜ^{Cu} are determined for the class Csj that shares features, by calculating the values of the vertical axis, that is, the scores θ_{q}^{Csj}, for all sections P1 through Pv of a histogram which is the classifying mechanism of the weak classifiers hₜ^{Cu} to generate a histogram such that the loss error J_{Csj}^{share} becomes minimal, by the steps described above. An example of a generated histogram is illustrated in FIG. 20. Note that in FIG. 20, the scores of sections P1, P2, and P3 are indicated as θ1, θ2, and θ3, respectively.

Next, how to minimize loss error J^{unshare} with respect to classes that do not share features will be considered. The loss error J_{Csj}^{unshare} for a class Csj which does not share features can be expressed by Formula (14) below. Here, the characteristic of the present embodiment is that features are shared. Therefore, the scores gₜ^{Cu}(rᵢ) for classes that do not share features are designated as a constant ρ^{Csj} as shown in Formula (15), and a constant ρ^{Csj} that yields the minimum loss error J_{Csj}^{unshare} is determined.

$$\begin{matrix}{J}_{Csj}^{unshare} = {\sum }_{i = 1}^{Ntchr} {{w}_{i}^{Csj} ( {z}_{i}^{Csj} - {g}_{t}^{Csj} ( {r}_{i} ) )}^{2} & ( 14 ) \\ {J}_{Csj}^{unshare} = {\sum }_{i = 1}^{Ntchr} {{w}_{i}^{Csj} ( {z}_{i}^{Csj} - {ρ}^{Csj} )}^{2} & ( 15 )\end{matrix}$$

If the value calculated by Formula (15) is minimized, the loss error J_{Csj}^{unshare} can be minimized. In order to minimize the value calculated by Formula (15), ρ^{Csj} may be set to a value such that the value calculated by Formula (15) partially differentiated by ρ^{Csj} becomes 0. Accordingly, ρ^{Csj} can be calculated by Formula (16) below.

$$\frac{\partial {J}_{Csj}^{unshare}}{\partial {ρ}^{Csj}} = 0 \\ ∴ - 2 {\sum }_{i = 1}^{Ntchr} {w}_{i}^{Csj} ( {z}_{i}^{Csj} - {ρ}_{i}^{Csj} ) = 0 \\ ∴ {ρ}^{Csj} = \frac{{\sum }_{i = 1}^{Ntchr} {w}_{i}^{Csj} \cdot {z}_{i}^{Csj}}{{\sum }_{i = 1}^{Ntchr} {w}_{i}^{Csj}} \qquad ( 16 )$$

The present embodiment determines the branching positions and branching structures of weak classifiers of a plurality of classes according to the learning results of the weak classifiers of each class, as described above. For this reason, the branching positions and the branching structures of the weak classifiers during multi class learning does not depend on the designer. As a result, classification of objects can be performed accurately and at high speeds using the generated classifiers. In addition, the occurrence of learning not converging will decrease compared to cases in which branching positions and branching structures are determined by designers, and as a result, the converging properties of learning can be improved.

In addition, learning results prior to branching may be inherited for learning of the weak classifiers following the branching. In this case, the weak classifiers are seamlessly connected prior to and following branching. Therefore, the consistency of classifying structures can be maintained in classifiers generated by the present invention. Accordingly, both classification accuracy and high classification speed can be realized.

As a result of experiments conducted by the present applicant, the stability and flexibility of learning of the classifiers generated by the present invention are higher than those of classifiers generated by the Joint Boost method. In addition, it was also found that the accuracy and detected speed of classifiers generated by the present invention were higher than those of classifiers generated by the Joint Boost method.

Note that the embodiment described above employs a histogram type classifying function as a classifying mechanism. Alternatively, it is possible to employ a decision tree as a classifying function. Hereinafter, determination of weak classifiers in the case that a decision tree is employed as the classifying function will be described. In the case that a decision tree is employed as the classifying function as well, the weak classifiers hₜ^{Cu} are determined such that classification loss error J_{wse} becomes minimal. For this reason, in the case that a decision tree is employed as the classifying function as well, calculations for minimizing the loss error J_{Csj}^{share} for a class Csj that shares features as shown in Formula (9) will be described. Note that in the following description, a decision tree is defined as shown in Formula (17) below. In Formula (17), Φₜ^{Csj} is a threshold value, and is defined in the filter for features. In addition, δ( ) is a delta function that assumes a value of 1 when rᵢ>Φₜ^{Csj} and assumes a value of 0 in all other cases. Further, aₜ^{Csj} and bₜ^{Csj} are parameters. By defining a decision tree in this manner, the relationship between the input and the output of the decision tree becomes that illustrated in FIG. 21.

gₜ^{Csj}(rᵢ)=aₜ^{Csj}·δ(rᵢ>φₜ^{Csj})+bₜ^{Csj} (17)

In the embodiment in which the classifying mechanism is a decision tree, the loss error J_{Csj}^{share} for a class Csj that shares features can be expressed by Formula (18) below.

$${J}_{Csj}^{share} = {\sum }_{i = 1}^{Ntchr} {{w}_{i}^{Csj} ( {z}_{i}^{Csj} - {g}_{t}^{Csj} ( {r}_{i } ) )}^{2} \qquad ( 18 )$$

If the value calculated by Formula (18) is minimized, the loss error J_{Csj}^{share} can be minimized. In order to minimize the value calculated by Formula (18), the values of aₜ^{Csj}+bₜ^{Csj} and bₜ^{Csj} may be set to a value such that the value calculated by Formula (18) partially differentiated by aₜ^{Csj} and bₜ^{Csj} respectively becomes 0. The value of aₜ^{Csj}+bₜ^{Csj} may be determined by partially differentiating the value calculated by Formula (18) by aₜ^{Csj} as shown in Formula (19) below. Note that rᵢ>φ_{q}^{Csj} beneath the Σ in Formula (19) indicates that the total sum of weights wᵢ^{Csj} when rᵢ>φ_{q}^{Csj} and products of the weights wᵢ^{Csj} and labels zᵢ^{Csj} are calculated. Accordingly, Formula (19) is equivalent to Formula (20).

$$\begin{matrix}\frac{\partial {J}_{Csj}^{share}}{\partial {a}_{t}^{Csj}} = 0 \\ \frac{\partial {J}_{Csj}^{share}}{\partial {a}_{t}^{Csj}} = 2 {\sum }_{i = 1}^{Ntchr} {w}_{i}^{Csj} ( {z}_{i}^{Csj} - {g}_{t}^{Csj} ( {r}_{i} ) \cdot ä ( {r}_{i} > {ö}_{t}^{Csj} ) ) = 0 \\ {\sum }_{{r}_{i} > {ö}_{t}^{Csj}} {w}_{i}^{Csj} ( {z}_{i}^{Csj} - {a}_{t}^{Csj} - {b}_{t}^{Csj} ) = 0 \\ ∴ {a}_{t}^{Csj} + {b}_{t}^{Csj} = \frac{{\sum }_{{r}_{i} > {ö}_{t}^{Csj}} {w}_{i}^{Csj} \cdot {z}_{i}^{Csj}}{{\sum }_{{r}_{i} > {ö}_{t}^{Csj}} {w}_{i}^{Csj}} & ( 19 ) \\ {a}_{t}^{Csj} + {b}_{t}^{Csj} = \frac{{\sum }_{i = 1}^{Ntchr} {w}_{i}^{Csj} {z}_{i}^{Csj} ä ( {r}_{i} > {ö}_{t}^{Csj} )}{{\sum }_{i = 1}^{Ntchr} {w}_{i}^{Csj} ä ( {r}_{i} > {ö}_{t}^{Csj} )} & ( 20 )\end{matrix}$$

Meanwhile, the value of bₜ^{Csj} may be set to a value such that the value calculated by Formula (18) partially differentiated by bₜ^{Csj} becomes 0, as shown in Formula (22) below.

$$\frac{\partial {J}_{Csj}^{share}}{\partial {b}_{t}^{Csj}} = 0$$

$$\frac{\partial {J}_{Csj}^{share}}{\partial {b}_{t}^{Csj}} = 2 {\sum }_{i = 1}^{Ntchr} {w}_{i}^{Csj} ( {z}_{i}^{Csj} - {g}_{t}^{Csj} ( {r}_{i} ) ) = 0$$

$${\sum }_{i = 1}^{Ntchr} {w}_{i}^{Csj} ( {z}_{i}^{Csj} - {a}_{t}^{Csj} ( {r}_{i} ) \cdot ä ( {r}_{i} > {ö}_{t}^{Csj} ) - {b}_{t}^{Csj} ) = 0$$

weights wᵢ^{Csj} are normalized, and therefore

$${\sum }_{i = 1}^{Ntchr} {w}_{i}^{Csj} = 1 \\ ∴ {\sum }_{i = 1}^{Ntchr} {w}_{i}^{Csj} {z}_{i}^{Csj} - {a}_{t}^{Csj} {\sum }_{{r}_{i} > {\ddot{o}}_{t}^{Csj}} {w}_{i}^{Csj} - {b}_{t}^{Csj} = 0 \\ ∴ {a}_{t}^{Csj} {\sum }_{{r}_{i} > {\ddot{o}}_{t}^{Csj}} {w}_{i}^{Csj} + {b}_{t}^{Csj} = {\sum }_{i = 1}^{Ntchr} {w}_{i}^{Csj} {z}_{i}^{Csj} \qquad ( 21 )$$

The value of bₜ^{Csj} can be calculated from Formula (20) and Formula (21).

$${b}_{t}^{Csj} = \frac{{\sum }_{i = 1}^{Ntchr} {w}_{i}^{Csj} {z}_{i}^{Csj} ä ( {r}_{i} \leq {ö}_{t}^{Csj} )}{{\sum }_{i = 1}^{Ntchr} {w}_{i}^{Csj} ä ( {r}_{i} \leq {ö}_{t}^{Csj} )} \qquad ( 22 )$$

Note that with respect to classes that do not share features in the case that the classifying mechanism is a decision tree, the values output by the decision tree may be designated as a constant ρ^{Csj}, and a constant ρ^{Csj} that yields the minimum loss error J_{Csj}^{unshare} may be determined in the same manner as in the case that the classifying mechanism is a histogram type classifying function. In this case, the constant ρ^{Csj} may be determined in the same manner as shown in Formula (16).

As described above, in the case that the classifying mechanism is a decision tree as well, the present invention determines the branching positions and the branching structures of weak classifiers of a plurality of classes according to the results of learning of the weak classifiers in each class. For this reason, the branching positions and the branching structures of the weak classifiers during multi class learning does not depend on a user. As a result, classification of objects can be performed accurately and at high speeds using the generated classifiers. In addition, the occurrence of learning not converging will decrease compared to cases in which branching positions and branching structures are determined by designers, and as a result, the converging properties of learning can be improved.

An apparatus 1 according to an embodiment of the present invention has been described above. However, a program that causes a computer to function as means corresponding to the learning data input section 10, the feature pool 20, the initializing section 30, the learning section 40, and the branching structure candidate pool 50 described above to perform the process illustrated in FIG. 8 is also an embodiment of the present invention. Further, a computer readable medium in which such a program is recorded is also an embodiment of the present invention.

What is claimed is:

1. A classifier generating apparatus, for generating classifiers, which are combinations of a plurality of weak classifiers, for discriminating objects included in detection target images by employing features extracted from the detection target images to perform multi class discrimination including a plurality of classes regarding the objects, comprising:
learning means, for determining branching positions and branching structures of the weak classifiers of the plurality of classes, according to the learning results of the weak classifiers in each of the plurality of classes.

2. A classifier generating apparatus as defined in claim 1, wherein:
the learning means performs learning of the weak classifiers of the plurality of classes, sharing only the features.

3. A classifier generating apparatus as defined in claim 2, further comprising:
learning data input means, for inputting a plurality of positive and negative learning data for the weak classifiers to perform learning for each of the plurality of classes; and
filter storage means, for storing a plurality of filters that extract the features from the learning data; wherein:
the learning means extracts the features from the learning data using filters selected from those stored in the filter storage means, and performs learning using the extracted features.

4. A classifier generating apparatus as defined in claim 3, wherein:
the learning means performs labeling with respect to all of the learning data to be utilized for learning according to degrees of similarity to positive learning data of classes to be learned, to stabilize learning.

5. A classifier generating apparatus as defined in claim 4, wherein the learning means performs learning by:
defining a total sum of weighted square errors of the outputs of weak classifiers at the same level in the plurality of classes with respect to the labels and input features;
defining the total sum of the total sums for the plurality of classes as classification loss error; and
determining weak classifiers such that the classification loss error becomes minimal.

6. A classifier generating apparatus as defined in claim 5, wherein:
the learning means is a means for calculating the classification loss error of the weak classifiers of each of the plurality of classes at levels for which judgments are made regarding whether branching is to be performed, and for determining the weak classifiers of these levels as branching positions when the amount of change from the classification loss error of an upper level and that of these levels is less than or equal to a predetermined threshold value.

7. A classifier generating apparatus as defined in claim 1, further comprising:
storage means, for storing a plurality of branching structures which are determined in advance; wherein:
the learning means is a means for selecting branching structures from among the plurality of branching structures such that branching loss errors become minimal at levels for which judgments are made regarding whether branching is to be performed.

8. A classifier generating apparatus as defined in claim 1, wherein:
the learning means inherits the learning results prior to branching for learning of the weak classifiers following the branching.

9. A classifier generating apparatus as defined in claim 1, wherein:
the branching structures include branching conditions and the number of branches that the branching structures branch into.

10. A classifier generating apparatus as defined in claim 2, wherein:
the filters define the positions of pixels within images represented by the learning data to be employed to calculate features, the calculating method for calculating the features using the pixel values of pixels at the positions, and sharing information regarding which classes the features are to be shared among.

11. A classifier generating method, for generating classifiers, which are combinations of a plurality of weak classifiers, for discriminating objects included in detection target images by employing features extracted from the detection target images to perform multi class discrimination including a plurality of classes regarding the objects, comprising:
a learning step, for determining branching positions and branching structures of the weak classifiers of the plurality of classes, according to the learning results of the weak classifiers in each of the plurality of classes.

12. A non transitory computer readable medium having a program recorded thereon that causes a computer to execute a classifier generating method, for generating classifiers, which are combinations of a plurality of weak classifiers, for discriminating objects included in detection target images by employing features extracted from the detection target images to perform multi class discrimination including a plurality of classes regarding the objects, comprising:
a learning procedure, for determining branching positions and branching structures of the weak classifiers of the plurality of classes, according to the learning results of the weak classifiers in each of the plurality of classes.
